(19) United States
(12) Patent Application Publication
(10) Pub. No.: US 2026/0359698 A1
(43) Pub. Date: Nov. 12, 2026

(54) Objective-Collapse Master Equation with Fixed epsilon - Methods, Hardware, and Systems for Parameter-Free Quantum-Collapse Dynamics Using Recognition-Physics Derived Collapse Strength

(71) Applicant: Jonathan Washburn, Austin, TX (US)

(72) Inventor: Jonathan Washburn, Austin, TX (US)

(21) Appl. No.: 19/654,982

(22) Filed: Apr. 22, 2026

Related U.S. Application Data
(60) Provisional application No. 63/794,523, filed on Apr. 25, 2025.

(51) Int. Cl. G06N 10/40

(52) U.S. Cl. CPC G06N 10/40

(57) ABSTRACT

A quantum state is evolved under an objective-collapse master equation having a fixed collapse strength. A state representation rho is updated using a Hamiltonian commutator contribution and a collapse contribution having a double-commutator structure. The collapse strength epsilon is fixed as epsilon=8*phi/pi, where phi=(1+sqrt(5))/2, and is not selected as a user-adjustable collapse-model fitting parameter. Implementations include software solvers configured to compute derivatives and integrate updated states, integrated circuits configured to compute collapse contributions and state updates using fixed-epsilon storage, real-time control systems configured to generate control signals for quantum hardware, cloud services configured to execute simulations and return results, and photonic systems configured to generate random bits from detection events.

### CROSS-REFERENCE TO RELATED APPLICATIONS

This application claims the benefit of U.S. Provisional Patent Application No. 63/794,523, filed on Apr. 25, 2025, the entire contents of which are incorporated herein by reference to the extent permitted by law.

### BACKGROUND OF THE INVENTION

Quantum information science, quantum measurement, and open quantum system modeling rely on the ability to accurately represent and evolve quantum states under both unitary dynamics and non-unitary effects associated with measurement, decoherence, and environment-induced loss of coherence. In practical computing and control contexts, such state evolution is often represented using a density matrix rho and a generator that includes a Hamiltonian contribution as well as additional terms capturing non-unitary behavior. Despite broad adoption of these techniques in simulation and device engineering, a persistent technical difficulty remains in connecting measurement-like state reduction to a physically grounded dynamical law that is both computationally implementable and sufficiently specific to yield unambiguous predictions across microscopic and macroscopic regimes.

In standard quantum mechanics, the evolution of a closed system is described as unitary and reversible, such as by the Schrödinger equation or its density-matrix form, while measurement yields definite outcomes that appear non-unitary and effectively irreversible. This disconnect is frequently referred to as the measurement problem. From an engineering perspective, the measurement problem is not merely philosophical: it complicates the design and verification of quantum simulation engines, device-control loops, and benchmarking methodologies because measurement-like dynamics are often introduced through modeling choices that can be difficult to justify, difficult to parameterize, and difficult to validate across different hardware platforms and operational regimes.

Objective-collapse models attempt to address this by postulating that collapse is a real physical process that occurs spontaneously or continuously, thereby producing definite outcomes without requiring an external measurement postulate. Representative examples include the GRW (Ghirardi-Rimini-Weber) model and CSL (Continuous Spontaneous Localization) models, which commonly rely on adjustable parameters such as a collapse rate and a localization length or similar scale parameters. These adjustable parameters are often selected to satisfy macroscopic definiteness while preserving microscopic quantum behavior. However, from the standpoint of robust simulation and hardware deployment, parameter freedom introduces multiple practical drawbacks. First, parameter selection can be uncertain or ambiguous, particularly when the parameters are not derived from first principles. Second, parameterized models can weaken falsifiability because negative experimental outcomes can sometimes be accommodated by parameter adjustment rather than decisive model rejection. Third, parameter tuning complicates software and hardware implementation because deployed systems may require configuration management, calibration workflows, or device-specific tuning to achieve expected behavior, and such tuning may be difficult to standardize across different experimental platforms.

Accordingly, there is a technical need for objective-collapse implementations in which the collapse strength is fixed by derivation rather than selected as a tunable model parameter. A fixed-collapse-strength approach can provide a uniform and reproducible collapse law that is suitable for consistent simulation and control across a wide range of quantum systems, and that yields concrete predictions that are not contingent on user-selected collapse-rate parameters. Such an approach can also reduce implementation complexity in deployed systems by eliminating collapse-parameter tuning, while providing a consistent basis for benchmarking, validation, verification, and formal analysis.

There is also a technical need for objective-collapse systems that are practically implementable in real computing and control environments, rather than being limited to abstract or purely theoretical formulations. In particular, there is a need for deterministic density-matrix simulation engines capable of evolving quantum states under an objective-collapse master equation; for trajectory-based alternatives that can reduce memory cost for large state spaces; for high-performance implementations using accelerators such as GPUs; for dedicated hardware embodiments including FPGA and ASIC configurations capable of real-time or near-real-time operation; for closed-loop control embodiments that can generate control signals for quantum hardware based on predicted or estimated collapse dynamics; for cloud-deployed embodiments capable of providing collapse simulation as a service; and for application embodiments including quantum benchmarking, decoherence prediction, validation pathways, and quantum-random-number generation.

The present invention addresses these and other technical problems by providing methods, systems, hardware, and computer-readable media configured to evolve a quantum state under an objective-collapse master equation that includes a fixed collapse strength derived from a recognition-physics framework, together with practical solver and implementation embodiments suitable for deployment in software, accelerators, dedicated hardware, real-time control loops, and networked or cloud environments.

### SUMMARY OF THE INVENTION

The present invention provides methods, systems, hardware, and computer-readable media for evolving a quantum state under an objective-collapse dynamical law having a fixed, recognition-physics-derived collapse strength. In various embodiments, the invention operates on a quantum state representation rho, which may be a density matrix representation of an ensemble or reduced state, and evolves rho in time under a generator that includes both a Hamiltonian term and a non-unitary collapse term. The invention is designed for practical implementation in software and hardware, including implementations using general-purpose processors, graphics processing units, reconfigurable logic devices, application-specific integrated circuits, photonic components, and cloud-deployed resources, and is further designed to provide outputs usable for quantum simulation, decoherence modeling, control-loop actuation, benchmarking, verification, and random-value generation.

In a first aspect, the invention provides a fixed collapse strength epsilon that is not selected as an adjustable collapse-model fitting parameter by a user. In exemplary embodiments, epsilon is defined in plain-text form as follows:

phi=(1+sqrt(5))/2

X_opt=phi/piepsilon=8*X_opt=8* phi/pi

In various embodiments, epsilon is treated as fixed in the sense that it is not a user-tunable collapse parameter, even though different implementations may store epsilon as a constant, compute epsilon from the defining formula, represent epsilon in floating-point or fixed-point formats, fuse epsilon in nonvolatile circuitry, compile epsilon into software, or convert between time representations as described herein.

In a second aspect, the invention provides an objective-collapse master equation configured to evolve a state rho in a time variable t8 expressed in units of an eight-tick recognition cycle, and further configured to optionally operate in SI time t (seconds) through a conversion coefficient gamma. In exemplary embodiments, the master equation is expressed in plain-text form as: d rho/d t8=−i [H, rho]−epsilon [C_hat, [C_hat, rho]] where H is a Hamiltonian or effective Hamiltonian, and C_hat is a Hermitian, dimensionless collapse operator. The double-commutator term may be expanded in plain-text form as: [C_hat, [C_hat, rho]]=C_hat\hat{ }2 rho−2 C_hat rho C_hat+rho C_hat\hat{ }2.

In some embodiments, the master equation is implemented in an equivalent Lindblad form, which can make complete positivity and trace preservation explicit: d rho/d t8 =−i [H, rho]+2*epsilon*(C_hat rho C_hat−(1/2){C_hat\hat{ }2, rho}) with Lindblad operator: L=sqrt(2* epsilon)*C_hat.

In some embodiments, time is expressed in SI seconds with:

tau8=8*tau0

t8=t/tau8

gamma=epsilon/tau8

and the master equation is expressed as:

d rho/d t=−i [H, rho]−gamma [C_hat, [C_hat, rho]]

where tau0 is an external calibration anchor used to relate an eight-tick time representation to SI time units, without introducing a user-tunable collapse strength.

In a third aspect, the invention provides solver and simulation embodiments for numerically integrating the objective-collapse master equation. In various embodiments, the solver may implement deterministic density-matrix evolution using one or more numerical integration schemes, including a Runge-Kutta integration embodiment and a Trotter-splitting embodiment. In some embodiments, the solver precomputes one or more operator products, superoperator structures, commutator caches, eigendecompositions, or other reusable intermediate quantities, including precomputation of C_hat\hat{ }2, to reduce repeated computation during time stepping. In some embodiments, the solver monitors one or more state-validity metrics such as trace, Hermiticity, positivity, and/or purity, and may apply correction procedures such as trace normalization consistent with the disclosed evolution.

In a fourth aspect, the invention provides accelerator and hardware embodiments in which all or part of the objective-collapse evolution is performed using specialized compute resources. In some embodiments, a GPU implementation performs matrix multiplications, commutator evaluations, and integration steps using a linear algebra library and parallel execution streams, optionally supporting multiple numeric precision formats for research and real-time operation. In some embodiments, an ASIC embodiment includes a datapath configured to compute the double-commutator structure C_hat\hat{ }2 rho-2 C_hat rho C_hat +rho C_hat\hat{ }2, together with storage for a fixed epsilon value, and an integration pipeline configured to update rho. In some embodiments, an FPGA embodiment implements a reconfigurable arithmetic fabric configured to perform split-step evolution, matrix arithmetic, and/or controller-loop operations in a time-bounded manner for experimental integration.

In a fifth aspect, the invention provides real-time feedback-control embodiments in which the evolved state rho is used to generate one or more outputs usable for quantum hardware control. In some embodiments, one or more observables are computed as expectation values from rho, and a control signal is generated based on an error between a target observable and a measured observable. In exemplary embodiments, such a relationship may be expressed in plain-text form as: e(t)=O_target(t)−O_measured(t) V_ctrl(t)=K_p*e(t).

In various embodiments, the control signal may comprise a voltage, current, waveform instruction, pulse parameter, gate correction, actuator command, or other device-specific control output, and the loop may be implemented using software, GPU resources, FPGA logic, ASIC logic, or combinations thereof.

In a sixth aspect, the invention provides additional deployment and application embodiments that broaden the utility and implementability of the disclosed systems. In some embodiments, stochastic unravelling embodiments evolve state vectors rather than full density matrices to reduce memory cost, and ensemble averaging may be used to recover density-matrix statistics. In some embodiments, multi-operator embodiments include multiple collapse operators, for example using a sum of double-commutator terms, while maintaining the fixed-collapse-strength framing. In some embodiments, relativistic or field-theoretic embodiments apply the collapse structure to field operators and/or lattice discretizations. In some embodiments, photonic embodiments use optical elements and detection events in connection with collapse evolution and may be used for random-value or random-bit generation. In some embodiments, cloud-based embodiments provide collapse simulation as a service through one or more network interfaces. In some embodiments, formal-verification embodiments provide verification of fixed-parameter relationships, structural properties of the evolution, and/or traceability of benchmark or implementation properties. Benchmark values, named platforms, example process nodes, and example validation scenarios described herein are exemplary and are not intended to limit the scope of the claims unless expressly recited in a claim.

This Summary is intended to introduce the invention in a manner that supports prosecution and claim drafting; it is not intended to identify essential features of the invention, and features described as part of one embodiment may be combined with features of another embodiment in any technically feasible manner unless expressly stated otherwise.

### BRIEF DESCRIPTION OF THE DRAWINGS

FIG. 1 is a block diagram of an overall objective-collapse simulation, control, and deployment system. FIG. 1 illustrates representative inputs including an initial quantum state, one or more Hamiltonians, and one or more collapse operators, as well as representative outputs including an updated state, one or more observables, control signals, and/or reports, and further illustrates that the system may be implemented using one or more computing resources and/or deployed via one or more interfaces.

FIG. 2 is a block diagram of a master-equation engine configured to generate a state derivative and updated state according to an objective-collapse master equation having a fixed collapse strength. FIG. 2 illustrates functional blocks that, in various embodiments, compute a unitary commutator term, compute an objective-collapse term including a double-commutator structure, apply a fixed epsilon coefficient, and generate an updated state and/or one or more monitored state metrics.

FIG. 3 is a flow diagram of solver preprocessing, cache generation, timestep control, and result generation for objective-collapse state evolution. FIG. 3 illustrates representative preprocessing steps including operator normalization and caching, construction of one or more reusable intermediate quantities, and a time-stepping loop that generates updated states and/or derived outputs.

FIG. 4 is a flow diagram of a Trotter-splitting and eigendecomposition embodiment for objective-collapse state evolution. FIG. 4 illustrates a split-step evolution process in which a unitary update and a collapse update are applied in a controlled order, and further illustrates an eigendecomposition-based collapse update pathway usable to reduce repeated computation in certain high-dimensional embodiments.

FIG. 5 is a block diagram of an application-specific integrated circuit (ASIC) implementation configured to compute an objective-collapse state derivative and integrate an updated quantum state using a fixed collapse strength. FIG. 5 illustrates representative hardware blocks including fixed-epsilon storage, a datapath configured to compute a double-commutator collapse term, an integration pipeline, and output logic configured to provide updated states and/or observables.

FIG. 6 is a block diagram of a real-time feedback-control loop between an objective-collapse simulator and quantum hardware. FIG. 6 illustrates a closed-loop arrangement in which measured observables from quantum hardware are provided to a simulator, a control error is determined relative to one or more targets, and control signals are generated for application to the quantum hardware.

FIG. 7 is a block diagram of a photonic and quantum-random-number-generation embodiment. FIG. 7 illustrates photonic elements and detection events that, in various embodiments, are used in connection with objective-collapse dynamics to generate random values and/or random bits, optionally with entropy estimation or certification.

FIG. 8 is a block diagram of a cloud-based objective-collapse simulation service. FIG. 8 illustrates a network-accessible interface configured to receive simulation inputs, schedule execution on one or more compute resources, generate objective-collapse simulation outputs, and return results and/or reports to one or more client devices.

### DETAILED DESCRIPTION OF THE INVENTION

The following Detailed Description is provided to enable any person skilled in the art to make and use the disclosed subject matter and to set forth the best mode contemplated by the inventors of carrying out the invention. The embodiments described herein are illustrative and not limiting. Variations, substitutions, and combinations of the disclosed features may be made without departing from the scope of the invention as defined by the claims.

As used herein, “a” and “an” mean one or more unless the context clearly indicates otherwise. The terms “comprising,” “including,” and “having” are open-ended and mean “including, but not limited to.” A “module,” “engine,” “block,” or “circuit” may refer to software, firmware, hardware, or any combination thereof. A “processor” may include a general-purpose processor, a graphics processing unit, a tensor/accelerator core, a reconfigurable logic device, an application-specific integrated circuit, or any combination thereof. The term “real-time” refers to a configuration capable of generating outputs within a controller loop or within an experiment-relevant update interval. In some embodiments, an update interval may be selected as 1 ms or less, 100 microseconds or less, or 10 microseconds or less depending on the controlled system and the selected solver or hardware implementation (examples; not limiting).

The invention, in various embodiments, evolves a quantum state representation according to an objective-collapse master equation having a fixed collapse strength derived from a recognition-physics framework. The quantum state representation is denoted herein as “rho,” which may be a density matrix representing an ensemble state, a reduced state, or another mixed-state representation. In alternative embodiments described herein, the invention may operate on a state-vector representation “psi” in connection with stochastic unravellings.

As used herein, “H” denotes a Hamiltonian or effective Hamiltonian that contributes a unitary commutator term to the state evolution. “C_hat” denotes a Hermitian, dimensionless collapse operator. In some embodiments, C_hat is produced by normalizing a physical operator C by a reference scale C0 such that: C_hat=C/C0 where C0 is selected such that C_hat is dimensionless. In some embodiments, C0 is a fixed reference scale associated with the recognition-physics framework and/or an externally calibrated reporting seam, as further described herein.

In some embodiments, C0 is selected as a predetermined reference scale for a selected operator family or deployment and is not adjusted to fit experimental outcomes. In such embodiments, selection of C0 is distinct from selection of the collapse strength epsilon, and epsilon remains fixed as disclosed herein.

As used herein, “t8” denotes time expressed in units associated with an eight-tick recognition-cycle representation. In some embodiments, the mapping between t8 and SI time t (seconds) is expressed using a calibration interval tau8 and an elementary tick tau0 such that:

tau8=8*tau0

t8=t/tau8

In such embodiments, tau0 is an external calibration anchor used to relate a recognition-time representation to SI reporting units and is not treated as an adjustable collapse-model parameter.

As used herein, “epsilon” denotes a fixed collapse strength. In exemplary embodiments, epsilon is defined in plain-text form as:

phi=(1+sqrt(5))/2

X_opt=phi/piepsilon=8* X_opt=8*phi/pi

In various embodiments, epsilon is fixed in the sense that it is not selected as a free collapse-rate or localization parameter to fit measurement outcomes, even though epsilon may be stored, represented, compiled, fused, or computed in different ways in different software and hardware implementations.

When the evolution is expressed in SI time t, a coefficient gamma may be used such that: gamma =epsilon/tau8 and the collapse strength remains fixed while its SI-time coefficient is determined through the reporting seam tau8.

For clarity, commutators and anticommutators are written as:
[A, B] =A B−B A
{A, B} =A B+B A

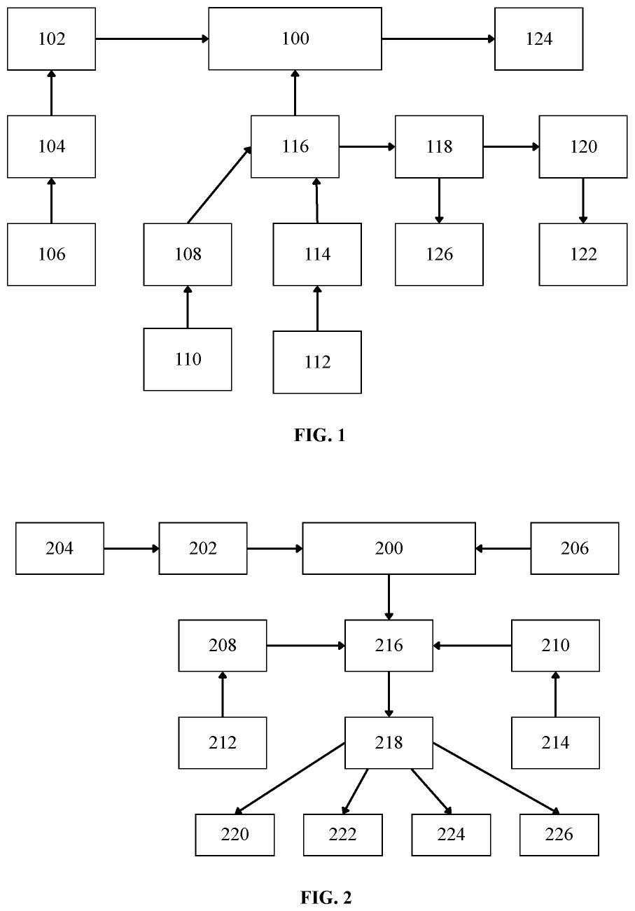

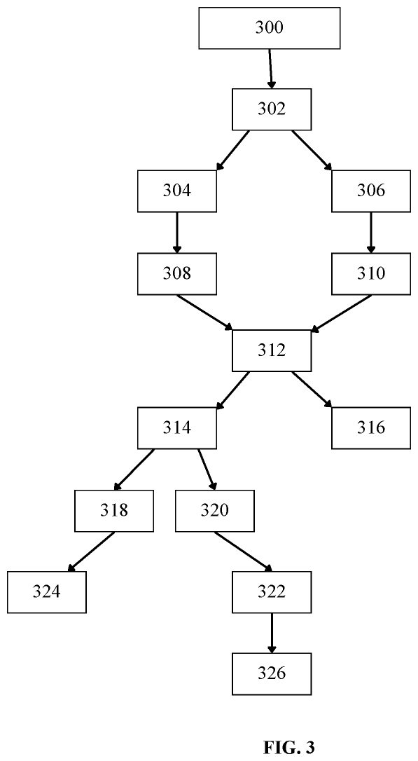

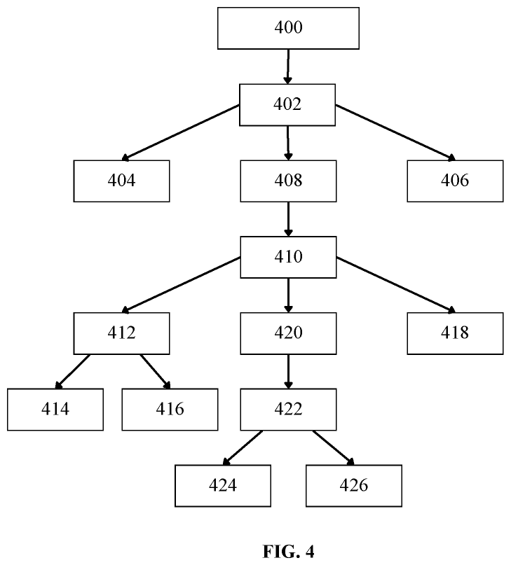

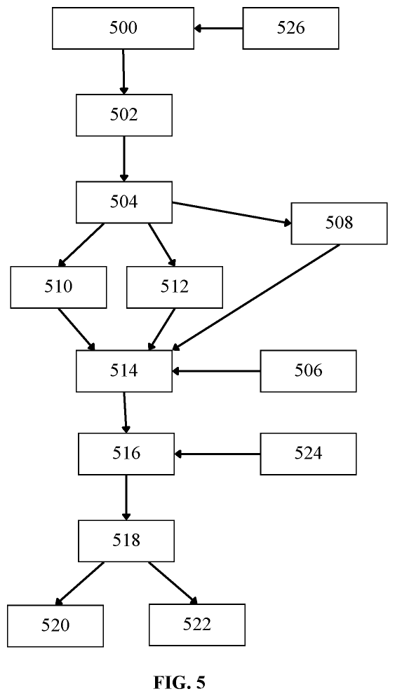

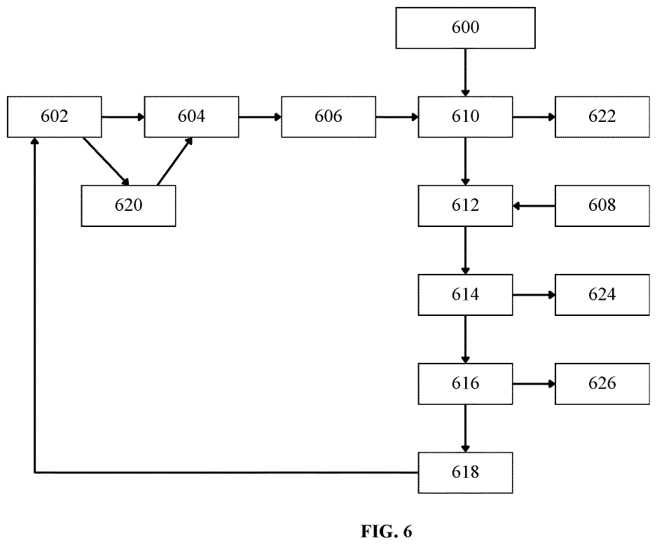

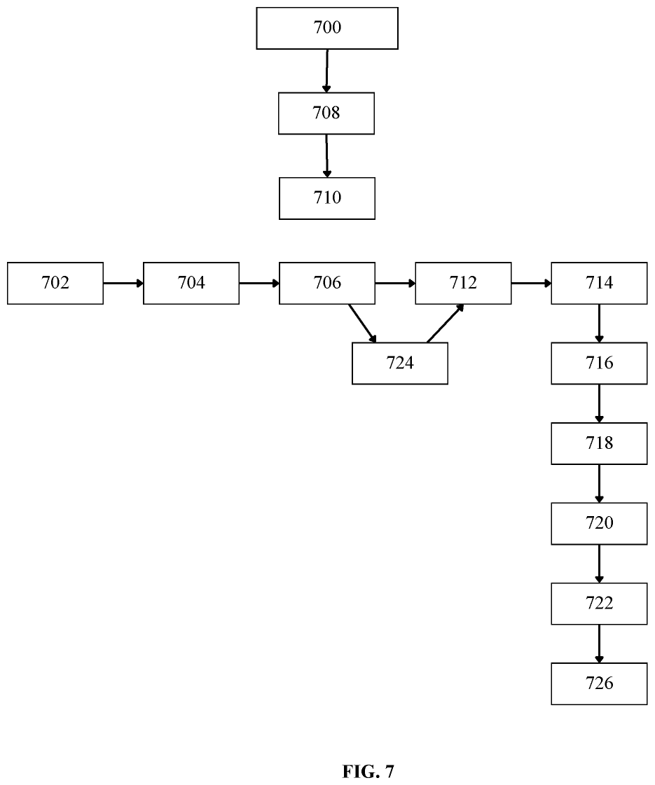

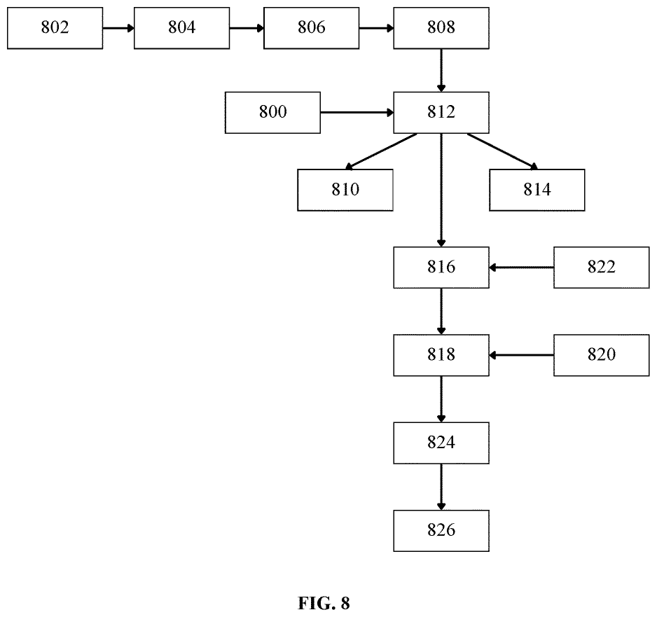

The invention may be implemented as computer-executable instructions stored on a non-transitory computer-readable medium, as one or more services executed on networked compute resources, as hardware logic, or as any combination thereof. The figures described below illustrate exemplary implementations and are referenced using reference numerals that are assigned in series per figure. In particular, FIG. 1 uses numerals in the 100 series, FIG. 2 uses numerals in the 200 series, FIG. 3 uses numerals in the 300 series, FIG. 4 uses numerals in the 400 series, FIG. 5 uses numerals in the 500 series, FIG. 6 uses numerals in the 600 series, FIG. 7 uses numerals in the 700 series, and FIG. 8 uses numerals in the 800 series. Within each figure series, reference numerals increase in intervals of two.

FIG. 1 illustrates an objective-collapse system 100 configured to evolve a quantum state under an objective-collapse master equation having a fixed collapse strength. In the illustrated embodiment, the objective-collapse system 100 includes a host workstation 102 having a processor 104 and memory 106. The memory 106 stores instructions that, when executed by the processor 104, cause the objective-collapse system 100 to perform the operations described herein, including receiving model inputs, generating state updates, and producing outputs usable for simulation, validation, control, and/or reporting.

In the embodiment of FIG. 1, the objective-collapse system 100 includes a Hamiltonian input module 108 configured to receive one or more Hamiltonians H. The Hamiltonian input module 108 may receive H in any suitable representation, including without limitation a matrix representation, an operator representation, a sparse representation, a factorized representation, a parameterized model representation, or an interface to a library capable of generating H for a selected physical model. In some embodiments, H is time-independent over an evolution interval, and in other embodiments H is time-dependent and is supplied as a function of time, schedule, or control setting.

The objective-collapse system 100 further includes a collapse-operator input module 110 configured to receive one or more collapse operators C_hat. In some embodiments, C_hat is selected from an operator family associated with a physical measurement channel or decoherence channel, including without limitation normalized position operators, normalized mass or mass-density operators, number operators, spin-projection operators, charge operators, photon-number operators, or field-theoretic smeared operators, provided that C_hat is Hermitian and dimensionless as implemented in the disclosed embodiments.

The objective-collapse system 100 further includes a fixed-epsilon module 112 configured to provide the fixed collapse strength epsilon. In some embodiments, the fixed-epsilon module 112 stores epsilon as a constant. In other embodiments, the fixed-epsilon module 112 computes epsilon from one or more defining relationships, including the relationships set forth in Section 9.1. In still other embodiments, the fixed-epsilon module 112 provides epsilon in a representation suited to a selected compute pathway, including floating-point, fixed-point, fused constant registers, or compiled constants. Regardless of representation, epsilon is not treated as a user-selected collapse-model fitting parameter in the disclosed embodiments.

The objective-collapse system 100 further includes a state initialization module 114 configured to receive or generate an initial quantum state. In density-matrix embodiments, the initial quantum state may be provided as rho0. In trajectory embodiments, the initial quantum state may be provided as psi0. In some embodiments, rho0 is constructed from one or more basis states, mixture weights, or measured-state estimates, and in some embodiments rho0 is received from an external simulation or measurement pipeline.

The objective-collapse system 100 further includes a solver core 116 configured to generate updated states by numerically integrating an objective-collapse master equation described in further detail below in connection with FIG. 2 through FIG. 4. In some embodiments, the solver core 116 executes on the processor 104. In other embodiments, the solver core 116 is implemented using one or more accelerators, including without limitation GPUs, reconfigurable logic devices, and ASIC implementations, including the ASIC embodiment described below with respect to FIG. 5.

The objective-collapse system 100 further includes an observables engine 118 configured to compute one or more outputs from the evolving quantum state. In some embodiments, the observables engine 118 computes expectation values of one or more observables O according to: <O>=Tr(rho O) and outputs one or more expectation values, statistics, or derived metrics. In some embodiments, the observables engine 118 computes one or more state validity metrics, including without limitation trace, Hermiticity, positivity, and/or purity, and reports such metrics for validation or control use.

The objective-collapse system 100 further includes a hardware control interface 120 configured to output control signals for a controlled quantum device or experimental system. In some embodiments, the hardware control interface 120 outputs voltages, currents, waveform instructions, pulse parameters, gate corrections, actuator commands, or other hardware-specific control outputs based on the evolving state and/or computed observables, as described below with respect to the feedback-control embodiment of FIG. 6.

The objective-collapse system 100 further includes a network/service interface 122 configured to communicate over one or more networks. In some embodiments, the network/service interface 122 transmits simulation inputs and receives simulation outputs in connection with a cloud-based simulation service, as described below with respect to FIG. 8. In other embodiments, the network/service interface 122 provides a local or remote interface for configuration, job control, result retrieval, and/or reporting.

The objective-collapse system 100 further includes a results store 124 configured to store one or more simulation outputs, intermediate results, logs, traceability artifacts, or reports. In some embodiments, the results store 124 stores time-series outputs of rho(t8) or derived observables, as well as solver configuration and calibration metadata sufficient to reproduce an output. The objective-collapse system 100 further includes a user interface 126 configured to present one or more simulation configurations, run status indicators, plots, outputs, reports, and/or warnings to a user.

In operation, the objective-collapse system 100 receives H through the Hamiltonian input module 108, receives one or more collapse operators C_hat through the collapse-operator input module 110, receives or generates an initial quantum state through the state initialization module 114, obtains epsilon through the fixed-epsilon module 112, and executes the solver core 116 to generate updated states and derived outputs. The objective-collapse system 100 outputs results via the observables engine 118, the hardware control interface 120, and/or the network/service interface 122, and stores selected outputs in the results store 124 and/or presents selected outputs via the user interface 126.

FIG. 2 illustrates a collapse engine 200 configured to generate a time derivative of a quantum state and to produce an updated quantum state according to an objective-collapse master equation having a fixed collapse strength. In the illustrated embodiment, the collapse engine 200 receives as inputs a density matrix rho 202, a Hamiltonian H 204, and a collapse operator C_hat 206. The collapse engine 200 further receives or accesses a fixed collapse strength epsilon, as described above with respect to the fixed-epsilon module 112 of FIG. 1, and applies epsilon as part of the non-unitary collapse contribution to the state evolution.

In various embodiments, the collapse engine 200 is configured to evolve the density matrix rho 202 in a time variable t8 expressed in units associated with an eight-tick recognition-cycle representation. In such embodiments, epsilon is dimensionless and fixed with respect to t8. In exemplary embodiments, epsilon is defined in plain-text form as:

phi=(1+sqrt(5))/2

X_opt=phi/piepsilon=8* X_opt=8*phi/pi

In some embodiments, time is expressed or reported in SI units using a calibration interval tau8 and an elementary tick tau 0, such that tau 8=8*tau0 and t8=t/tau8. In such embodiments, the evolution may be expressed in SI time t using gamma=epsilon/tau8 while preserving the fixed nature of epsilon as a collapse strength.

In the embodiment of FIG. 2, the collapse engine 200 includes a unitary term evaluator 208 configured to compute a commutator contribution associated with Hamiltonian evolution. In density-matrix form, the Hamiltonian contribution is a commutator [H, rho], and the unitary term evaluator 208 computes −i [H, rho] or an equivalent representation suitable for numerical integration.

The collapse engine 200 further includes a double-commutator evaluator 210 configured to compute an objective-collapse term having a double-commutator structure. In exemplary embodiments, the collapse engine 200 computes a state derivative according to an objective-collapse master equation expressed in plain-text form as: d rho/d t8=−i [H, rho]-epsilon [C_hat, [C_hat, rho]] where C_hat is Hermitian and dimensionless. The double-commutator structure may be expanded in plain-text form as: [C_hat, [C_hat, rho]] =C_hat\hat{ }2 rho-2 C_hat rho C_hat+rho C_hat\hat{ }2.

Accordingly, in embodiments using the expanded form, the double-commutator evaluator 210 is configured to compute one or more intermediate products, including C_hat\hat{ }2 rho, C_hat rho C_hat, and rho C_hat\hat{ }2, and to combine such intermediate products to yield the double-commutator collapse contribution.

In the embodiment of FIG. 2, the collapse engine 200 further includes a Lindblad-form converter 212. In some embodiments, the Lindblad-form converter 212 is configured to represent the same objective-collapse evolution in an equivalent Lindblad form, which in many cases makes explicit that the evolution is completely positive and trace-preserving when implemented as disclosed herein. In exemplary embodiments, the Lindblad-form expression is: d rho/d t8=−i [H, rho]+2*epsilon*(C_hat rho C_hat−(1/2){C_hat\hat{ }2, rho}) with Lindblad operator: L=sqrt(2* epsilon)*C_hat.

In embodiments that implement the evolution in Lindblad form, the Lindblad-form converter 212 may provide an internal representation that is convenient for certain numerical integrators, for certain operator factorization strategies, and/or for certain correctness checks, while still yielding the same physical evolution as the double-commutator form for Hermitian C_hat.

In the embodiment of FIG. 2, the collapse engine 200 further includes an epsilon-weighted collapse term block 214 configured to apply the fixed collapse strength epsilon to the collapse contribution. In various embodiments, the epsilon-weighted collapse term block 214 accesses epsilon from storage, accesses epsilon from compiled constants, accesses epsilon from fixed nonvolatile circuitry, and/or computes epsilon from its defining formula, and then applies epsilon as a scalar coefficient multiplying the collapse contribution. In some embodiments, the epsilon-weighted collapse term block 214 further converts between a t8-based evolution and an SI-time evolution by applying gamma =epsilon/tau8 when the derivative is expressed with respect to SI time t.

The outputs of the unitary term evaluator 208 and the double-commutator evaluator 210 (and/or the Lindblad-form converter 212) are combined in a combined derivative output block 216 to form a state derivative consistent with the disclosed objective-collapse master equation. The collapse engine 200 further includes a state update output block 218 configured to provide an updated state, for example rho(t8+dt8), based on the computed derivative and a selected numerical integration method and timestep dt8. The state update output block 218 may provide updated states to downstream modules including the solver workflow of FIG. 3, the hardware embodiment of FIG. 5, the feedback-control loop of FIG. 6, and the cloud service of FIG. 8.

In some embodiments, the collapse engine 200 further includes a trace monitor 220 configured to monitor Tr(rho) and to detect numerical drift or instability. In some embodiments, the collapse engine 200 further includes a positivity monitor 222 configured to detect whether rho remains a valid density matrix (for example, by checking eigenvalues or by applying a positivity-preserving integrator design). In some embodiments, the collapse engine 200 further includes a purity monitor 224 configured to compute Tr(rho\hat{ }2) and to track purity decay behavior consistent with collapse and dephasing. In some embodiments, the collapse engine 200 further includes an observable output block 226 configured to compute one or more expectation values <O>according to <O>=Tr(rho O) and to output such values for reporting, benchmarking, and/or control.

In some embodiments, the positivity monitor 222 applies a positivity tolerance delta_pos. For example, when an estimated minimum eigenvalue of rho is less than-delta_pos, the system flags a positivity event and, in response, reduces a timestep size and/or recomputes an integration step, where delta_pos may be selected as an implementation tolerance such as 10\hat{ }12 to 10\hat{ }6 (example ranges; not limiting).

In some embodiments, the collapse engine 200 may also be used as a sub-engine within a stochastic unravelling implementation in which trajectories are evolved and then combined to recover ensemble behavior. In such embodiments, the double-commutator or Lindblad structure disclosed herein provides a consistent ensemble-level description while trajectory-level updates may be implemented using noise increments and normalization operations, as described in further detail below.

The next subsection describes solver preprocessing and timestep-loop embodiments configured to call the collapse engine 200 repeatedly to produce a time series of states and outputs.

FIG. 3 illustrates a solver workflow 300 configured to evolve a quantum state under the objective-collapse master equation described above with respect to FIG. 2, using one or more numerical integration strategies and one or more preprocessing operations that reduce repeated computation during time stepping. In various embodiments, the solver workflow 300 is executed by the solver core 116 of FIG. 1 and repeatedly calls the collapse engine 200 of FIG. 2 to obtain a state derivative and generate updated states.

In the embodiment of FIG. 3, the solver workflow 300 begins with an input parser 302 configured to receive and validate simulation inputs. In some embodiments, the input parser 302 receives a Hamiltonian H, one or more collapse operators C_hat, an initial quantum state rho0, a time range, a timestep specification, and one or more output requests (for example, a list of observables to compute or one or more report formats). In some embodiments, the input parser 302 validates that H is Hermitian or effectively Hermitian for the represented model, validates that each C_hat is Hermitian, validates that each C_hat is dimensionless as represented, and validates that the initial state rho0 is a valid density matrix (for example, trace-one and positive semidefinite within numerical tolerances). In some embodiments, the input parser 302 further receives configuration information for time units, including whether the evolution is performed in t8 units or SI time units, and if SI time is used, receives or accesses a calibration parameter tau0 and computes tau8=8*tau0 and gamma=epsilon/tau8 as described above.

After input parsing, the solver workflow 300 stores and/or formats the Hamiltonian in a Hamiltonian cache 304. In some embodiments, the Hamiltonian cache 304 stores H in a dense matrix form. In other embodiments, the Hamiltonian cache 304 stores H in a sparse form, a factorized form, a block-structured form, or another representation suitable for repeated commutator evaluation. In some embodiments, the Hamiltonian cache 304 stores one or more derived quantities associated with H, including without limitation a precomputed propagator for split-step methods, an eigendecomposition for certain unitary updates, or a compiled kernel representation for accelerator execution.

The solver workflow 300 further stores and/or formats each collapse operator in a collapse-operator cache 306. In some embodiments, the collapse-operator cache 306 stores one or more normalized operators C_hat associated with different collapse channels. In some embodiments, the collapse-operator cache 306 stores C_hat in a representation that supports repeated multiplication with rho, including dense, sparse, structured, or factorized forms, and may store metadata associated with each operator, such as a selected normalization scale C0 or a selected operator family identity.

In the embodiment of FIG. 3, the solver workflow 300 further includes a C_hat squared cache 308 configured to store one or more precomputed quantities C_hat\hat{ }2. In embodiments that implement the double-commutator collapse term in expanded form, precomputing C_hat\hat{ }2 reduces repeated computation in each timestep because the expanded form includes C_hat\hat{ }2 rho and rho C_hat\hat{ }2. In a single-operator embodiment, the solver workflow 300 may compute C_hat\hat{ }2 once during initialization and store it in the C_hat squared cache 308. In a multi-operator embodiment, the solver workflow 300 may compute C_hat_k\hat{ }2 for each operator C_hat_k and store the results in the C_hat squared cache 308.

The solver workflow 300 further includes a superoperator constructor 310 configured to construct one or more reusable structures for commutator evaluation and/or collapse evaluation. In some embodiments, the superoperator constructor 310 constructs a representation of the commutator [H, ·] and/or constructs a representation of the double commutator [C_hat, [C_hat,·]] as an operator acting on rho. In some embodiments, the superoperator constructor 310 constructs a Lindblad-form representation and stores a representation of the Lindblad operator L=sqrt(2*epsilon)*C_hat or its components. In some embodiments, the superoperator constructor 310 constructs a compiled kernel representation for accelerated execution, including kernels that compute H rho, rho H, C_hat rho C_hat, C_hat\hat{ }2 rho, and rho C_hat\hat{ }2, and combines such kernels into a derivative evaluation pathway.

The solver workflow 300 further includes an epsilon factor injector 312 configured to apply the fixed collapse strength epsilon to the collapse contribution and to incorporate epsilon into derivative evaluation in a manner suited to the chosen solver strategy. In some embodiments, the epsilon factor injector 312 multiplies the double-commutator output by epsilon as a scalar coefficient. In other embodiments, the epsilon factor injector 312 incorporates epsilon into a Lindblad operator L=sqrt(2*epsilon)*C_hat. In still other embodiments, the epsilon factor injector 312 incorporates epsilon into a compiled or fused kernel representation, including by hard-coding epsilon into an accelerator kernel, by storing epsilon in a constant-memory region, or by storing epsilon in a fixed register for repeated multiplication. In SI-time embodiments, the epsilon factor injector 312 may apply gamma=epsilon/tau8 instead of epsilon when derivatives are expressed with respect to SI time t rather than t8.

The solver workflow 300 further includes a timestep controller 314 configured to select dt8 (or dt) for numerical integration. In some embodiments, the timestep controller 314 uses a fixed timestep selected based on a desired resolution or stability criterion. In other embodiments, the timestep controller 314 implements adaptive timestep control based on an error estimate. In such embodiments, the timestep controller 314 interacts with an error estimator 316 configured to estimate local truncation error and to propose increases or decreases of dt8. For example, in an adaptive Runge-Kutta embodiment, the error estimator 316 may use an embedded method to estimate local error and the timestep controller 314 may adjust dt8 to meet a target tolerance. In split-step embodiments, the timestep controller 314 may select a slice duration based on operator norms, stability limits, or user-requested output sampling intervals.

In some embodiments, the timestep controller 314 enforces a bounded timestep interval for numerical stability. For example, the timestep controller 314 clamps dt8 to an interval [dt8_min, dt8_max] selected for a deployment, such as dt8_min=10\hat{ }−6 and dt8_max=10\hat{ }−1 (example values; not limiting), while still adjusting dt8 based on an error estimate.

In some embodiments, the solver workflow 300 includes a trace renormalizer 318 configured to enforce or restore Tr(rho)=1 within numerical tolerances. While the disclosed evolution is trace preserving in exact arithmetic, finite precision and repeated matrix operations can accumulate numerical drift. Accordingly, in some embodiments the trace renormalizer 318 periodically rescales rho by Tr(rho) or applies another trace correction consistent with maintaining a valid density matrix. In some embodiments, the trace renormalizer 318 cooperates with validity checks performed by the trace monitor 220, positivity monitor 222, and/or purity monitor 224 described above in connection with FIG. 2.

In some embodiments, a trace deviation threshold is used to trigger renormalization. For example, when |Tr(rho)−1| exceeds a trace tolerance delta_tr, the system applies trace normalization, where delta_tr may be selected as an implementation tolerance such as 10\hat{ }−12 to 10\hat{ }−6 (example ranges; not limiting).

The solver workflow 300 further includes an observable calculator 320 configured to compute one or more outputs from rho during or after time stepping. In some embodiments, the observable calculator 320 computes expectation values=Tr(rho O) for one or more observables O. In some embodiments, the observable calculator 320 computes derived metrics such as coherence measures, purity Tr(rho\hat{ }2), entropy measures, or other application-specific outputs. In some embodiments, outputs of the observable calculator 320 are used for feedback control as described below with respect to FIG. 6, including by producing measured or predicted values used to compute an error signal.

The solver workflow 300 further includes an output formatter 322 configured to package results in one or more formats. In some embodiments, the output formatter 322 outputs time series of rho(t8) or sampled density matrices. In other embodiments, the output formatter 322 outputs only selected observables, summary statistics, or reports. In some embodiments, the output formatter 322 outputs control outputs to the hardware control interface 120, outputs responses to the network/service interface 122, or writes outputs to the results store 124.

The solver workflow 300 further includes a benchmark logger 324 configured to record performance metrics, configuration metadata, and traceability information. In some embodiments, the benchmark logger 324 records dimension size, timestep selection, runtime per step, memory usage, and error metrics. In some embodiments, the benchmark logger 324 records the identity of the chosen solver strategy (for example, split-step vs. Runge-Kutta), the representation of H and C_hat, the numerical precision used, and the execution target (for example, CPU vs. GPU vs. ASIC). Any benchmark values or platform references recorded or described herein are exemplary and are not intended to limit the scope of the invention unless expressly recited in a claim.

The solver workflow 300 further includes a state history store 326 configured to store intermediate states and/or final states for later analysis, reporting, reproducibility, and validation. In some embodiments, the state history store 326 stores a complete time series of rho for later computation of derived metrics. In other embodiments, the state history store 326 stores only sampled states, checkpoints, or compressed representations. In some embodiments, the state history store 326 stores outputs together with sufficient metadata to reproduce the simulation, including H and C_hat identifiers, epsilon representation, timestep history, and calibration information.

In operation, the solver workflow 300 initializes caches and reusable structures (including the Hamiltonian cache 304, the collapse-operator cache 306, the C_hat squared cache 308, and/or structures constructed by the superoperator constructor 310), applies the fixed collapse strength via the epsilon factor injector 312, selects timesteps via the timestep controller 314 and error estimator 316, repeatedly evaluates state derivatives using the collapse engine 200, optionally applies trace correction via the trace renormalizer 318, computes observables via the observable calculator 320, formats outputs via the output formatter 322, logs performance and traceability via the benchmark logger 324, and stores results via the state history store 326.

The next subsection describes a split-step (Trotter-splitting) integrator embodiment and an eigendecomposition pathway configured to reduce per-step computation for certain operator classes and state dimensions.

FIG. 4 illustrates a Trotter integrator 400 configured to evolve a quantum state under the disclosed objective-collapse master equation using a split-step strategy. The Trotter integrator 400 is an exemplary embodiment of a numerical integration approach that, in some implementations, can reduce computational cost and/or improve stability by separating a unitary evolution contribution from a collapse evolution contribution and applying the contributions in a controlled sequence over a timestep. In various embodiments, the Trotter integrator 400 is executed by the solver core 116 of FIG. 1 in accordance with the solver workflow 300 of FIG. 3 and repeatedly calls the collapse engine 200 of FIG. 2.

In the embodiment of FIG. 4, the Trotter integrator 400 receives a current state rho 402 at a current time t8. The Trotter integrator 400 further receives or accesses a Hamiltonian contribution and constructs or accesses a unitary propagator U 404 and an adjoint propagator U_dagger 406. In exemplary embodiments, the unitary propagator U 404 is expressed in plain-text form as: U(dt8)=exp(−i H dt8) and the adjoint propagator U_dagger 406 is expressed in plain-text form as: U_dagger(dt8)=U(dt8)\hat{ }dagger where dt8 is a timestep expressed in t8 units. In various embodiments, U 404 and U_dagger 406 may be computed directly as matrix exponentials, may be approximated using polynomial or rational approximations, may be obtained from an eigendecomposition of H, may be obtained from a product formula, or may be obtained from a compiled or hardware-accelerated propagator implementation. In some embodiments, U 404 and U_dagger 406 are recomputed each timestep when H is time-dependent, and in other embodiments U 404 and U_dagger 406 are computed once and reused when H is time-independent over an evolution interval.

The Trotter integrator 400 further receives or accesses a collapse contribution represented by a collapse superoperator D_C_hat 408. In exemplary embodiments, the collapse superoperator D_C_hat 408 acts on a state rho according to: D_C_hat(rho)=[C_hat, [C_hat, rho]] where C_hat is Hermitian and dimensionless and where the double commutator may be expanded as: [C_hat, [C_hat, rho]]=C_hat\hat{ }2rho-2 C_hat rho C_hat+rho C_hat\hat{ }2.

The collapse term in the master equation is then represented as epsilon*D_C_hat(rho). In some embodiments, D_C_hat 408 is implemented using the expanded double-commutator form and matrix multiplications; in other embodiments, D_C_hat 408 is implemented using an equivalent Lindblad form or an equivalent operator representation that yields the same evolution for Hermitian C_hat.

In the embodiment of FIG. 4, the Trotter integrator 400 includes a matrix exponential block 410 configured to compute or approximate a collapse update associated with the collapse superoperator D_C_hat 408. In an exemplary split-step embodiment, the collapse update may be represented as an exponential acting on rho, such that a collapse-update operator exp(−epsilon*dt8*D_C_hat) is applied to rho 402. In an exemplary embodiment, the split-step update performed by the Trotter integrator 400 is expressed in plain-text form as: rho(t8+dt8)=U(dt8)*(exp(−epsilon*dt8*D_C_hat) rho(t8))*U(dt8)\hat{ }dagger.

This expression is provided as an illustrative split-step form and does not exclude higher-order splitting schemes, symmetric splitting schemes, multi-stage splitting schemes, or other product-formula variants.

In the embodiment of FIG. 4, the matrix exponential block 410 may compute exp(−epsilon*dt8*D_C_hat) using one or more numerical techniques. In some embodiments, the matrix exponential block 410 uses a series approximation, a scaling-and-squaring method, a Krylov subspace method, or another matrix exponential method. In other embodiments, the matrix exponential block 410 avoids explicit superoperator exponentiation by applying an equivalent closed form derived from the eigendecomposition of C_hat, as described below.

In particular, the embodiment of FIG. 4 includes an eigendecomposition of C_hat block 412 configured to compute an eigendecomposition of C_hat. In some embodiments, the eigendecomposition is computed once at initialization when C_hat is time-independent, and results are stored for reuse. The eigendecomposition of C_hat block 412 outputs an eigenvalue store 414 and an eigenvector store 416. In some embodiments, the eigenvalue store 414 stores eigenvalues {c_i} of C_hat, and the eigenvector store 416 stores an eigenbasis {|i>} such that C_hat|i>=c_i |i>.

In embodiments using the eigendecomposition, the collapse-exponential operator 418 uses the eigendecomposition to apply the collapse contribution efficiently. For Hermitian C_hat, the double-commutator structure produces dephasing in the eigenbasis of C_hat. Accordingly, in some embodiments, the collapse update can be applied by transforming rho into the eigenbasis of C_hat, applying a damping factor to off-diagonal elements, and transforming back. In one exemplary implementation pathway, the collapse-exponential operator 418 performs the following operations: (i) transform rho into the eigenbasis of C_hat using the eigenvector store 416; (ii) apply element-wise attenuation factors based on differences between eigenvalues from the eigenvalue store 414; and (iii) transform the result back to the original basis. In such embodiments, this pathway can reduce per-step computational cost relative to repeated full matrix multiplications for certain state dimensions and operator structures, while remaining consistent with the disclosed objective-collapse evolution.

The embodiment of FIG. 4 further includes a split-step combiner 420 configured to apply unitary and collapse updates in a selected order to produce a propagated state 422. In some embodiments, the split-step combiner 420 applies a unitary update followed by a collapse update. In other embodiments, the split-step combiner 420 applies a collapse update followed by a unitary update. In still other embodiments, the split-step combiner 420 applies a symmetric splitting sequence, such as a half-step unitary update, a full-step collapse update, and a half-step unitary update. The choice of splitting sequence may be selected based on error tolerance, stability requirements, computational cost, and the relative magnitudes of the unitary and collapse contributions.

The embodiment of FIG. 4 further includes a reduced-complexity path 424 configured to select or enable computational shortcuts in appropriate regimes. In some embodiments, the reduced-complexity path 424 selects an eigendecomposition pathway when C_hat is time-independent and when the cost of initial eigendecomposition is amortized over many timesteps. In some embodiments, the reduced-complexity path 424 selects a sparse multiplication pathway when H and/or C_hat are sparse. In some embodiments, the reduced-complexity path 424 selects a lower-precision arithmetic mode for real-time control use cases while maintaining a higher-precision mode for validation use cases, provided that state validity checks remain satisfied within tolerances.

The embodiment of FIG. 4 further includes a large-dimension embodiment block 426 indicating that the split-step and eigendecomposition approach is particularly suitable for certain high-dimensional cases, such as when the state dimension is sufficiently large that repeated dense matrix multiplications become computationally expensive. In such embodiments, the Trotter integrator 400 may be used in connection with reduced representations, sector decompositions, symmetry-reduced bases, or other dimensionality-reduction techniques, provided that the resulting state evolution remains consistent with the disclosed objective-collapse law for the represented system.

In various embodiments, the outputs of the Trotter integrator 400, including the propagated state 422 and any associated state validity metrics, are provided to the observable calculator 320 of FIG. 3, are stored in the state history store 326, are used to generate control outputs as described below with respect to FIG. 6, and/or are returned as part of a cloud service response as described below with respect to FIG. 8.

The next subsection describes an exemplary hardware embodiment in which one or more parts of the derivative computation and/or the integration pipeline are implemented using an application-specific integrated circuit, including a fixed-epsilon storage element and a datapath configured to compute the double-commutator collapse contribution.

FIG. 5 illustrates an application-specific integrated circuit (ASIC) 500 configured to perform objective-collapse state evolution using the fixed collapse strength epsilon and the double-commutator collapse structure described above. The ASIC 500 may be implemented as a standalone integrated circuit, as a co-processor coupled to a host processor, as a subsystem within a quantum-control platform, or as a component within a larger system-on-chip. In various embodiments, the ASIC 500 accelerates evaluation of the objective-collapse master equation by implementing one or more of the derivative-evaluation pathways and/or integration pathways in dedicated hardware.

In the embodiment of FIG. 5, the ASIC 500 includes an input interface 502 configured to receive one or more inputs, including without limitation the current state rho, a Hamiltonian H, one or more collapse operators C_hat, one or more timestep parameters, and/or one or more configuration parameters. In some embodiments, the input interface 502 is configured to receive matrix or vector data via a high-speed bus, a memory-mapped interface, a streaming interface, or another suitable interconnect. In some embodiments, the input interface 502 receives data from a host processor, from a GPU, from an FPGA, from a cloud-connected edge device, or from a dedicated quantum-control system.

The ASIC 500 further includes on-chip memory 504 configured to store one or more quantities used during state evolution. In various embodiments, the on-chip memory 504 stores one or more of: the current state rho, one or more cached operator representations, one or more precomputed products such as C_hat\hat{ }2, intermediate multiplication results, integrator state variables, and/or output buffers. In some embodiments, the on-chip memory 504 includes SRAM, register files, embedded nonvolatile memory, cache structures, or combinations thereof.

The ASIC 500 further includes a fixed-epsilon fuse register 506 configured to store the fixed collapse strength epsilon. In some embodiments, the fixed-epsilon fuse register 506 stores epsilon as a constant in a predetermined numeric representation, including floating-point or fixed-point formats. In some embodiments, the fixed-epsilon fuse register 506 is implemented using one-time programmable circuitry, electrically programmable fuses, read-only memory, masked constants, or other nonvolatile circuitry suitable for storing a constant value. In some embodiments, the fixed-epsilon fuse register 506 is “tamper resistant” in the sense that the stored epsilon value is not modifiable by user code or runtime configuration. In other embodiments, epsilon is stored as a hard-coded constant in combinational logic or as a compiled microcode constant. Regardless of storage technique, epsilon is treated as fixed and is not used as a user-tunable collapse-model fitting parameter.

The ASIC 500 further includes a commutator engine 508 configured to compute one or more commutator-based contributions to the state derivative. In some embodiments, the commutator engine 508 computes the Hamiltonian contribution −i[H, rho] by computing one or more products H rho and rho H and forming their difference. In some embodiments, the commutator engine 508 accesses H and rho from the on-chip memory 504 and writes intermediate results back to on-chip memory 504 for use by downstream datapaths.

The ASIC 500 further includes a C_hat squared multiplier path 510 configured to compute one or more intermediate products involving C_hat\hat{ }2. In embodiments using the expanded double-commutator form, the collapse contribution includes terms C_hat\hat{ }2 rho and rho C_hat\hat{ }2. Accordingly, in some embodiments the C_hat squared multiplier path 510 is configured to compute C_hat\hat{ }2 once (for example during initialization) and store it, and then to compute C_hat\hat{ }2 rho and rho C_hat\hat{ }2 during derivative evaluation. In other embodiments, the C_hat squared multiplier path 510 is configured to compute C_hat\hat{ }2 on demand and/or to compute C_hat\hat{ }2 rho directly using fused multiply-accumulate logic without explicitly storing C_hat\hat{ }2 as a separately materialized matrix, depending on design tradeoffs between area, bandwidth, and latency.

The ASIC 500 further includes a C_hat rho C_hat path 512 configured to compute the intermediate product C_hat rho C_hat used in the expanded double-commutator form: [C_hat, [C_hat, rho]]=C_hat\hat{ }2 rho−2 C_hat rho C_hat+rho C_hat\hat{ }2.

In some embodiments, the C_hat rho C_hat path 512 is implemented using a pipelined matrix multiplication datapath configured to accept input blocks of C_hat and rho, compute a partial product C_hat rho, and then multiply by C_hat again to form C_hat rho C_hat. In some embodiments, the C_hat rho C_hat path 512 is implemented using a tiled or blocked multiplication strategy to reduce memory bandwidth and to increase arithmetic intensity.

The ASIC 500 further includes a derivative accumulator 514 configured to combine intermediate terms to form a complete state derivative consistent with the disclosed objective-collapse master equation. In some embodiments, the derivative accumulator 514 combines the unitary contribution from the commutator engine 508 with the collapse contribution formed from the outputs of the C_hat squared multiplier path 510 and the C_hat rho C_hat path 512. In some embodiments, the derivative accumulator 514 applies the epsilon coefficient from the fixed-epsilon fuse register 506 by multiplying the collapse contribution by epsilon. In some embodiments, the derivative accumulator 514 applies a conversion factor gamma =epsilon/tau8 when operating in SI-time mode, while still relying on a fixed epsilon value. In some embodiments, the derivative accumulator 514 performs complex arithmetic for complex-valued rho and H, and in other embodiments the derivative accumulator 514 performs real arithmetic for real-valued representations or for structured cases where real arithmetic is sufficient.

The ASIC 500 further includes an integrator pipeline 516 configured to compute an updated state from the state derivative. In some embodiments, the integrator pipeline 516 implements a fixed-step integrator such as an explicit Euler step, a midpoint step, or a Runge-Kutta family step, depending on design targets and stability requirements. In other embodiments, the integrator pipeline 516 implements a split-step or operator-splitting update in which unitary and collapse contributions are applied in sequence. In some embodiments, the integrator pipeline 516 is configured to process one timestep per clock cycle or per bounded number of cycles, and may include one or more pipeline stages, local storage registers, and scheduling logic to support throughput targets.

The ASIC 500 further includes a trace normalizer 518 configured to enforce or restore trace normalization Tr(rho)=1 within hardware tolerances. Although the disclosed evolution is trace preserving in exact arithmetic, finite precision arithmetic and truncation can introduce drift, and the trace normalizer 518 may rescale rho, apply a correction to diagonal terms, or perform another normalization procedure consistent with maintaining a valid density matrix. In some embodiments, the trace normalizer 518 operates periodically rather than every timestep, and in other embodiments the trace normalizer 518 operates every timestep, depending on numeric precision and stability targets.

The ASIC 500 further includes an observable extractor 520 configured to compute one or more outputs from the updated state. In some embodiments, the observable extractor 520 computes one or more expectation values=Tr(rho O) for selected observables O. In some embodiments, the observable extractor 520 computes one or more state metrics, such as purity Tr(rho\hat{ }2), diagonal population values, coherence indicators, or other application-specific metrics.

The ASIC 500 further includes a control-output block 522 configured to output control-relevant values, such as one or more expectation values, errors, or actuation signals. In some embodiments, the control-output block 522 is used in connection with the real-time feedback-control loop described below with respect to FIG. 6. In some embodiments, the control-output block 522 outputs one or more values to a host processor for higher-level control computation. In other embodiments, the control-output block 522 outputs signals directly to a hardware interface driving a quantum device.

The ASIC 500 further includes a clock domain 524 configured to provide timing and synchronization for pipeline stages and interfaces, and a power-management block 526 configured to manage power states, clock gating, voltage scaling, or other power-management functions. In some embodiments, the power-management block 526 enables a low-power mode for idle intervals and a high-throughput mode for simulation or control intervals.

In operation, the ASIC 500 receives rho and operator inputs via the input interface 502, stores selected quantities in on-chip memory 504, applies the fixed epsilon value stored in the fixed-epsilon fuse register 506, computes commutator and double-commutator contributions using the commutator engine 508, the C_hat squared multiplier path 510, and the C_hat rho C_hat path 512, combines the contributions in the derivative accumulator 514 to form a state derivative, produces an updated state using the integrator pipeline 516, optionally normalizes the state using the trace normalizer 518, computes one or more outputs using the observable extractor 520, and outputs results and/or control signals via the control-output block 522.

The next subsection describes an exemplary real-time feedback-control embodiment in which the objective-collapse evolution outputs are used to generate control signals for quantum hardware in a closed-loop arrangement.

FIG. 6 illustrates a control system 600 configured to operate an objective-collapse simulator in a real-time feedback loop with quantum hardware. In this embodiment, the control system 600 is configured to (i) obtain measured data from a quantum device, (ii) compute or update an estimated quantum state using the disclosed objective-collapse evolution, (iii) compute one or more control errors relative to one or more targets, and (iv) output one or more control signals to the quantum device to influence subsequent device evolution or measurement outcomes. The control system 600 may be implemented using software executed by a host processor, using accelerator hardware, using an ASIC such as ASIC 500 described above with respect to FIG. 5, using networked resources, or using combinations thereof.

In the embodiment of FIG. 6, the control system 600 includes a quantum device 602. The quantum device 602 may be any quantum system capable of being acted upon by external control signals and capable of producing measurement outputs. By way of example and without limitation, the quantum device 602 may comprise a trapped-ion device, a superconducting qubit device, a neutral-atom device, a photonic quantum device, a spin-based device, a quantum sensor, or another quantum system in which state evolution and measurement are relevant to control performance. The quantum device 602 may be operated in an experimental environment or a deployed environment depending on the use case.

The control system 600 further includes a sensor/readout path 604 configured to obtain measurement outputs from the quantum device 602. In some embodiments, the sensor/readout path 604 includes one or more detectors, digitizers, signal-conditioning circuits, time-tagging modules, or measurement controllers that produce measured values associated with one or more observables of the quantum device 602. In some embodiments, the sensor/readout path 604 provides raw measurement outcomes, and in other embodiments the sensor/readout path 604 provides processed values such as estimated expectation values, state-population estimates, or error syndromes.

The control system 600 further includes a measured observable input 606 configured to provide one or more measured values to the downstream control computation. In some embodiments, the measured observable input 606 provides a measured expectation value O_measured(t). In other embodiments, the measured observable input 606 provides a vector or set of measurements corresponding to multiple observables, multiple qubits, multiple modes, multiple detectors, and/or multiple measurement times.

The control system 600 further includes a target observable input 608 configured to provide one or more target values. In some embodiments, the target observable input 608 provides a desired expectation value O_target(t). In other embodiments, the target observable input 608 provides a target state specification, a target distribution, a target fidelity, a target stabilizer syndrome, a target coherence level, or another target metric from which a control error can be formed.

The control system 600 further includes a collapse simulator 610 configured to compute an evolved quantum state using the objective-collapse master equation described above. In various embodiments, the collapse simulator 610 comprises the objective-collapse system 100 of FIG. 1 and/or includes the collapse engine 200 of FIG. 2 and the solver workflow 300 of FIG. 3. In some embodiments, the collapse simulator 610 evolves an estimated state rho forward in time using the fixed epsilon collapse strength and one or more collapse operators C_hat appropriate to the controlled system. In some embodiments, the collapse simulator 610 receives the measured observable input 606 and uses it to update an estimated state, for example by conditioning, filtering, or state-estimation procedures consistent with the control architecture. In some embodiments, the collapse simulator 610 is configured to compute one or more predicted observables O_predicted(t) from the evolved state, for example using=Tr(rho O). In some embodiments, the collapse simulator 610 operates fully in t8 units; in other embodiments, the collapse simulator 610 operates in SI time using gamma =epsilon/tau8 as described above.

The control system 600 further includes an error calculator 612 configured to compute an error signal representing a difference between a target and a measured or predicted value. In one exemplary embodiment, the error calculator 612 computes an error in plain-text form as: e(t)=O_target(t)−O_measured(t).

In other embodiments, the error calculator 612 computes a vector error for multiple observables, a weighted error, a cost-function error, or another control objective metric. In some embodiments, the error calculator 612 computes an error between a target and a predicted value produced by the collapse simulator 610, such as e(t)=O_target(t)−O_predicted(t). In some embodiments, the error calculator 612 computes an error using both measured and predicted values, for example by blending measured and predicted values to reduce noise or to compensate for measurement delays.

The control system 600 further includes a controller gain block 614 configured to map the error signal to a control command. In some embodiments, the controller gain block 614 implements proportional control using a gain K_p. In such embodiments, the control command may be expressed in plain-text form as: V_ctrl(t)=K_p*e(t).

In other embodiments, the controller gain block 614 implements proportional-integral control, proportional-integral-derivative control, model predictive control, adaptive control, reinforcement-learned control, or another control law. In some embodiments, the controller gain block 614 includes gain scheduling based on operating regimes, device calibrations, or a measured noise floor. In some embodiments, the controller gain block 614 is configured to generate one or more control parameters including without limitation voltages, currents, pulse amplitudes, pulse durations, pulse phases, waveform coefficients, detunings, gate parameters, or other actuation parameters used to control the quantum device 602.

The control system 600 further includes a control-voltage generator 616 configured to generate a control output in a form usable by the quantum device 602. While labeled as a “control-voltage generator” in FIG. 6, the control-voltage generator 616 is not limited to voltage outputs and may generate any suitable actuation signal. In some embodiments, the control-voltage generator 616 produces an analog voltage or current. In other embodiments, the control-voltage generator 616 produces a digital waveform instruction, a pulse-sequence description, a gate-command sequence, or a control word. In some embodiments, the control-voltage generator 616 includes a digital-to-analog converter, a waveform generator, a pulse modulator, or other actuation circuitry.

The control system 600 further includes an actuator interface 618 configured to deliver the generated control signals to the quantum device 602. In various embodiments, the actuator interface 618 may include electrical couplings, optical couplings, microwave couplings, RF couplings, magnetic couplings, mechanical couplings, or combinations thereof, depending on the device type. In some embodiments, the actuator interface 618 delivers control signals to trap electrodes, control lines, resonators, lasers, modulators, or other actuation elements of the quantum device 602.

The result of applying the control signal is reflected in an updated device state 620, representing that the quantum device 602 evolves under both its intrinsic dynamics and the applied control signals. The updated device state 620 may be measured again through the sensor/readout path 604, thereby closing the loop.

In some embodiments, the control system 600 further includes a loop timing monitor 622 configured to monitor loop latency, update rate, and synchronization. In some embodiments, the loop timing monitor 622 ensures that the collapse simulator 610 and the controller computation operate within a time budget consistent with the control objective. In some embodiments, loop timing data is recorded for validation, traceability, and tuning of the controller gain block 614.

In some embodiments, the control system 600 includes an ASIC embodiment path 624 indicating that one or more computations in the loop are performed using an ASIC implementation such as ASIC 500. For example, in some embodiments the ASIC embodiment path 624 accelerates derivative evaluation, integration, expectation-value computation, or combinations thereof to meet a real-time constraint. In some embodiments, the control system 600 includes a networked control path 626 indicating that one or more computations are performed using a network-connected resource, such as a remote compute node, an edge compute platform, or a cloud service, provided that latency constraints are satisfied for the intended control use case.

In operation, the control system 600 obtains measured values from the quantum device 602 via the sensor/readout path 604 and measured observable input 606, compares measured and/or predicted values with targets via the target observable input 608 and error calculator 612, generates a control command using the controller gain block 614 and control-voltage generator 616, delivers control signals via the actuator interface 618, and repeats the process while monitoring timing using the loop timing monitor 622. The collapse simulator 610 provides model-based prediction of collapse-induced decoherence and/or state evolution under a fixed collapse strength, enabling control actions that compensate for, adapt to, or exploit the disclosed objective-collapse dynamics.

The next subsection describes a photonic and quantum-random-number-generation embodiment in which photonic detection events and objective-collapse dynamics are used to generate random values and/or random bits, optionally with entropy estimation or certification.

FIG. 7 illustrates a photonic system 700 configured to generate random values and/or random bits using photonic components and detection events in connection with objective-collapse dynamics having a fixed collapse strength epsilon. In various embodiments, the photonic system 700 may be used as (i) a quantum random number generator (QRNG), (ii) an entropy source for cryptographic key material, (iii) a randomness test platform for validating collapse-driven stochasticity, and/or (iv) a photonic demonstration platform for collapse evolution using an operator channel that is naturally implemented in photonic hardware. The photonic system 700 may be implemented as a laboratory system, an integrated photonic system, a chip-scale photonic module, or a hybrid system including optical and electronic subsystems.

In the embodiment of FIG. 7, the photonic system 700 includes a photon source 702 configured to generate one or more photons or photonic excitations. In various embodiments, the photon source 702 may comprise a laser source, a single-photon source, a heralded photon source, a spontaneous parametric down-conversion source, a quantum-dot source, an attenuated coherent source configured for a desired photon statistics regime, or another suitable optical source. In some embodiments, the photon source 702 is configured to generate pulses or time-binned photonic events to support discrete sampling intervals for random-bit extraction.

The photonic system 700 further includes a beam splitter 704 configured to split a photonic mode into two or more optical paths. In some embodiments, the beam splitter 704 is a 50/50 beam splitter. In other embodiments, the beam splitter 704 implements a different splitting ratio selected for balancing detector efficiencies, compensating for optical loss, or meeting a desired sampling distribution. The photonic system 700 further includes a phase shifter 706 configured to modify the relative phase between optical paths and/or to implement a controllable interferometric configuration. In some embodiments, the phase shifter 706 is used for calibration, bias balancing, or test modes in which the output distribution is intentionally skewed to verify that downstream whitening and/or entropy estimation behaves as expected.

In the embodiment of FIG. 7, the photonic system 700 further includes a photonic collapse simulator 708 configured to implement, approximate, or utilize objective-collapse dynamics as part of a randomness-generation pathway. In various embodiments, the photonic collapse simulator 708 corresponds to the objective-collapse system 100 of FIG. 1 and/or includes the collapse engine 200 of FIG. 2 and the solver workflow 300 of FIG. 3. In some embodiments, the photonic collapse simulator 708 maintains and evolves a quantum state representation (for example rho or psi) associated with the photonic system 700. In some embodiments, the photonic collapse simulator 708 evolves such a state according to the disclosed objective-collapse master equation having fixed epsilon, and uses one or more operators corresponding to photonic observables or photonic measurement channels.

In some embodiments, the photonic system 700 includes a photon-number operator input 710 configured to supply a collapse operator corresponding to photon number, mode occupancy, or a related photonic observable. For example, in some embodiments, the collapse operator C_hat used by the photonic collapse simulator 708 comprises a normalized photon-number operator n_hat or a normalized number-difference operator associated with two output modes of the beam splitter 704. In such embodiments, C_hat is selected to be Hermitian and dimensionless, consistent with the disclosed objective-collapse master equation. In some embodiments, C_hat is selected so that eigenstates correspond to distinct detection outcomes or distinct mode-occupancy outcomes, thereby providing a measurement channel suitable for random-outcome generation while still being compatible with the fixed-epsilon collapse dynamics described herein.

The photonic system 700 further includes a detector array 712 configured to detect photons or photonic events from one or more optical paths. In various embodiments, the detector array 712 may include avalanche photodiodes, superconducting nanowire single-photon detectors, photomultiplier tubes, integrated photodetectors, or other suitable detection technologies. The detector array 712 generates detection events that are provided to an event processor 714.

The event processor 714 is configured to process detection events into a form suitable for random-bit extraction and/or for use by the photonic collapse simulator 708. In some embodiments, the event processor 714 performs time tagging, coincidence detection, dead-time correction, detector-efficiency compensation, or other signal-processing operations. In some embodiments, the event processor 714 produces discrete outcomes corresponding to a detection at a first detector, a detection at a second detector, a detection in a particular time bin, a detection in a particular polarization channel, or a detection in another distinguishable measurement channel. In some embodiments, the event processor 714 provides measurement outcomes back to the photonic collapse simulator 708 as measurement records used for state update, filtering, conditioning, or validation testing.

The photonic system 700 further includes a random-bit extractor 716 configured to generate random values and/or random bits from the processed event stream. In one exemplary embodiment, the random-bit extractor 716 maps mutually exclusive detector events (for example “left detector fired” versus “right detector fired”) to bit values (for example “0” and “1”). In some embodiments, the random-bit extractor 716 performs whitening, debiasing, or hashing to reduce bias introduced by detector asymmetry, optical loss differences, or other implementation imperfections. In some embodiments, the random-bit extractor 716 outputs raw bits and also outputs whitened bits, and stores metadata enabling audit or traceability of the whitening procedure.

The photonic system 700 further includes an entropy certifier 718 configured to estimate and/or certify an entropy measure of the generated bitstream or of the underlying physical process. In some embodiments, the entropy certifier 718 computes a min-entropy estimate, a statistical test suite output, or another entropy indicator. In some embodiments, the entropy certifier 718 uses model-based information derived from the photonic collapse simulator 708 to estimate an expected correlation time or an expected decoherence time associated with successive bits. In some embodiments, the entropy certifier 718 uses the fixed epsilon collapse strength and the selected collapse operator C_hat to compute, bound, or estimate a decorrelation property and uses such information as part of an entropy report, while still treating any empirical measurement outcomes as dominant for certification purposes.

The photonic system 700 further includes a key-generation module 720 configured to use the generated random bits as key material, seeds, nonces, salts, or other cryptographic primitives. In some embodiments, the key-generation module 720 performs one or more key-derivation procedures, one or more privacy-amplification procedures, and/or one or more secure storage procedures. In some embodiments, the key-generation module 720 is used in connection with a secure communication protocol, a quantum key distribution protocol, a classical key distribution protocol, or another security protocol requiring high-quality randomness.

The photonic system 700 further includes a communication interface 722 configured to provide random-bit outputs and/or reports to external systems. In some embodiments, the communication interface 722 transmits random-bit outputs to a local host system. In other embodiments, the communication interface 722 transmits random-bit outputs over a network connection, including to a cloud service, an edge device, a secure enclave, or a hardware security module. In some embodiments, the communication interface 722 also transmits entropy reports or validation reports produced by the entropy certifier 718.

The photonic system 700 further includes an optical path network 724 representing one or more optical paths, couplers, waveguides, polarization controllers, filters, resonators, interferometers, or other optical elements connecting the photon source 702, beam splitter 704, phase shifter 706, and detector array 712. In some embodiments, the optical path network 724 is implemented in free space; in other embodiments it is implemented in fiber; and in still other embodiments it is implemented as an integrated photonic circuit.

The photonic system 700 further includes an output bitstream 726 representing the produced random bits and/or random values. In some embodiments, the output bitstream 726 comprises raw bits, debiased bits, and/or cryptographically conditioned bits. In some embodiments, the output bitstream 726 is accompanied by metadata including timing information, entropy estimates, health-test results, device configuration information, and/or traceability information.

In operation, the photon source 702 generates photonic events that propagate through the optical path network 724 and are split by the beam splitter 704, optionally conditioned by the phase shifter 706, and detected by the detector array 712. The event processor 714 converts detection events into discrete outcomes, and the random-bit extractor 716 generates random bits from such outcomes. In embodiments using model-based support, the photonic collapse simulator 708 evolves a state representation under the disclosed objective-collapse dynamics using a photonic collapse operator provided through the photon-number operator input 710, and outputs one or more model-based metrics that can be used for validation, monitoring, and/or entropy reporting by the entropy certifier 718. The key-generation module 720 may optionally generate cryptographic key material, and the communication interface 722 outputs the output bitstream 726 and associated reports.

The next subsection describes a cloud-based objective-collapse simulation service configured to receive simulation inputs over a network, schedule execution on one or more compute resources, and return simulation outputs and/or reports to one or more clients.

FIG. 8 illustrates a cloud simulation service 800 configured to provide objective-collapse simulation as a network-accessible service. In various embodiments, the cloud simulation service 800 receives simulation inputs (including a Hamiltonian H, one or more collapse operators C_hat, an initial quantum state rho0 or psi0, a time range, and solver configuration parameters), executes an objective-collapse evolution using the fixed collapse strength epsilon described herein, and returns one or more simulation outputs to a requesting client. The cloud simulation service 800 may be implemented on one or more servers, clusters, containerized execution environments, virtual machines, GPU clusters, accelerator pools, or other networked compute resources, and may further be implemented as a multi-tenant service, a single-tenant service, a private cloud service, or a hybrid service.

In the embodiment of FIG. 8, the cloud simulation service 800 communicates with a client device 802. The client device 802 may comprise a workstation, a laptop, a quantum-control host computer, a laboratory instrument controller, an embedded system, a mobile device, or any computing device configured to submit simulation requests and receive responses. In some embodiments, the client device 802 corresponds to the host workstation 102 of FIG. 1, and in other embodiments the client device 802 is a remote device distinct from any local simulation hardware.

The cloud simulation service 800 includes an API gateway 804 configured to receive requests from the client device 802. In various embodiments, the API gateway 804 may implement a REST interface, a gRPC interface, a message-queue interface, a web socket interface, or another network interface. In some embodiments, the API gateway 804 supports authenticated requests and enforces rate limits, quota policies, and/or access policies.

The cloud simulation service 800 further includes a request parser 806 configured to parse simulation inputs from received requests. In some embodiments, the request parser 806 parses a Hamiltonian representation, one or more collapse operator representations, and an initial state representation. In some embodiments, the request parser 806 parses solver configuration inputs including a solver selection (e.g., split-step vs. Runge-Kutta), timestep control parameters, precision settings, requested observables, requested outputs, and/or requested report types. In some embodiments, the request parser 806 validates that the received Hamiltonian representation and collapse operator representations conform to expected structural properties, including that the collapse operator C_hat is Hermitian and dimensionless as represented and that the input state is a valid density matrix or state vector within numerical tolerances.

The cloud simulation service 800 further includes a job scheduler 808 configured to schedule simulation execution on one or more compute resources. In some embodiments, the job scheduler 808 assigns a request to a CPU pool, a GPU pool, an accelerator pool, or another compute pool based on input dimension size, requested latency, requested precision, and available resources. In some embodiments, the job scheduler 808 supports batch jobs, interactive jobs, priority jobs, and/or real-time jobs, and may support queueing and backpressure when resources are constrained.

The cloud simulation service 800 further includes a GPU cluster 810 representing one or more GPU-equipped compute nodes usable to execute objective-collapse simulations. In some embodiments, the GPU cluster 810 comprises one or more servers having one or more GPUs and one or more high-throughput interconnects. In some embodiments, simulations are executed using a linear algebra library or a compiled kernel representation. In other embodiments, simulations are executed on CPU resources rather than GPU resources, or using mixed CPU/GPU execution strategies. While FIG. 8 depicts a GPU cluster 810 as a representative compute resource, the cloud simulation service 800 is not limited to GPUs and may include reconfigurable logic resources, ASIC accelerator resources, or other compute resources.

The cloud simulation service 800 further includes a simulation engine 812 configured to execute the objective-collapse evolution using the fixed collapse strength epsilon. In various embodiments, the simulation engine 812 corresponds to the objective-collapse system 100 of FIG. 1 and includes the collapse engine 200 of FIG. 2 and the solver workflow 300 of FIG. 3. In some embodiments, the simulation engine 812 executes a split-step (Trotter-splitting) integrator as described above with respect to FIG. 4. In other embodiments, the simulation engine 812 executes another deterministic integrator or a stochastic unravelling integrator. In various embodiments, the simulation engine 812 applies epsilon as a fixed collapse strength and does not treat epsilon as a user-tunable collapse-model fitting parameter.

In some embodiments, the cloud simulation service 800 includes a state/time database 814 configured to store one or more simulation results. In some embodiments, the state/time database 814 stores a time series of rho(t8) and/or sampled states at requested intervals. In other embodiments, the state/time database 814 stores only derived observables and omits storage of full state histories for efficiency. In some embodiments, the state/time database 814 stores simulation metadata sufficient for reproducibility, including representations or identifiers of H and C_hat, solver configuration, timestep history, precision, and the representation and/or storage policy for epsilon. In some embodiments, the state/time database 814 stores per-job traceability information and/or audit logs.

The cloud simulation service 800 further includes an observable calculator 816 configured to compute one or more observables and outputs from the evolving state. In some embodiments, the observable calculator 816 computes expectation values=Tr(rho O) for one or more observables O requested by the client device 802. In some embodiments, the observable calculator 816 computes state validity metrics including trace and purity. In some embodiments, the observable calculator 816 computes derived summary metrics, including coherence metrics, decoherence rates, fitted time constants, or other application-specific metrics.

The cloud simulation service 800 further includes a response generator 818 configured to generate a response for transmission to the client device 802. In various embodiments, the response generator 818 returns full state histories, sampled states, observable time series, summary metrics, and/or report files. In some embodiments, the response generator 818 returns a report describing simulation inputs, configuration, runtime, and outputs. In some embodiments, the response generator 818 returns a job identifier and provides a later retrieval interface for large results.

The cloud simulation service 800 further includes an authentication block 820 configured to authenticate users, devices, and/or requests. In some embodiments, the authentication block 820 supports API keys, tokens, certificates, or other authentication mechanisms. The cloud simulation service 800 further includes an accounting block 822 configured to record usage, enforce quotas, and/or generate billing records or resource utilization records. In some embodiments, the accounting block 822 records compute time, memory usage, accelerator usage, and data transfer volumes associated with each job.

The cloud simulation service 800 further includes a dashboard interface 824 configured to provide a user interface for job submission, monitoring, and result retrieval. In some embodiments, the dashboard interface 824 allows users to configure simulation parameters, select solver embodiments, view progress indicators, and download results. In some embodiments, the dashboard interface 824 provides visualization of observables and/or state metrics over time.

The cloud simulation service 800 further includes a downloadable report 826 representing one or more report files generated by the service. In some embodiments, the downloadable report 826 includes simulation results and plots. In some embodiments, the downloadable report 826 includes traceability information such as solver configuration, operator identities, epsilon definition, time-unit conventions, and validation results. In some embodiments, the downloadable report 826 includes benchmark information, provided as exemplary and non-limiting performance indicators.

In operation, the client device 802 submits a simulation request to the API gateway 804. The request parser 806 parses and validates the request. The job scheduler 808 schedules the simulation for execution on available compute resources, such as the GPU cluster 810. The simulation engine 812 executes the objective-collapse evolution using the fixed collapse strength epsilon and generates one or more states and outputs. Results are stored, as appropriate, in the state/time database 814. Observables and derived metrics are computed by the observable calculator 816. The response generator 818 generates an output response, which may include a downloadable report 826 accessible through the dashboard interface 824. Authentication and access control are handled through the authentication block 820, and usage is recorded through the accounting block 822. The client device 802 receives the response and may display, store, or further process results.

This cloud-based embodiment enables objective-collapse simulation to be provided as a service for use cases including decoherence benchmarking, model-based experiment planning, validation testing, and distributed simulation workflows, while preserving the parameter-free fixed collapse strength epsilon and the disclosed objective-collapse dynamics.

The disclosed objective-collapse dynamics operate on one or more collapse operators denoted herein as C_hat. As described above, in various embodiments C_hat is Hermitian and dimensionless and is selected to represent an objective-collapse channel associated with a physical observable, a measurement-like interaction, an effective decoherence channel, and/or a recognition-physics-based collapse mechanism. This section describes operator normalization and representative operator families suitable for use with the disclosed fixed-epsilon objective-collapse master equation.

In various embodiments, a physical operator C is converted into a dimensionless collapse operator C_hat using a normalization scale C0 such that: C_hat=C/C0.

The normalization scale C0 may be selected such that the resulting C_hat is dimensionless and has a magnitude appropriate to the represented system. In some embodiments, C0 is a fixed reference scale derived from or associated with a recognition-physics framework and/or a fixed reference constant (e.g., a reference mass scale, reference length scale, reference energy scale, or reference field scale). In other embodiments, C0 is selected as a fixed reporting scale associated with a particular measurement channel or device class. In some embodiments, C0 is stored and reused as part of a model definition, such that different simulations or deployments use consistent scaling for a given operator family. Importantly, selection of C0 is distinct from selection of epsilon: epsilon remains fixed as disclosed herein and is not treated as a tunable collapse-model fitting parameter.

In some embodiments, normalization is performed to achieve numerical stability and consistent scaling across different implementations. For example, in some embodiments C0 is selected so that eigenvalues of C_hat lie within a bounded numeric range for typical operating conditions, which can reduce numerical overflow or underflow and improve stability of exponentiation steps, split-step methods, or iterative integrators. In some embodiments, C0 is selected so that the resulting C_hat is compatible with fixed-point arithmetic in hardware embodiments, including ASIC implementations such as ASIC 500.

In some embodiments, the collapse operator C_hat is chosen so that it is Hermitian by construction. Hermiticity of C_hat is useful because, in the disclosed objective-collapse master equation, a Hermitian C_hat yields a double-commutator structure that is naturally interpreted as a dephasing-type dissipator in the eigenbasis of C_hat and supports a Lindblad-form representation. In some embodiments, the solver workflow validates Hermiticity of C_hat within numerical tolerances and rejects or modifies inputs that violate Hermiticity, for example by symmetrizing an operator as (C_hat+C_hat\hat{ }dagger)/2 when appropriate to the represented physical model.

In various embodiments, the collapse operator C_hat is selected from one or more operator families. The following operator families are exemplary and non-limiting. Any given embodiment may use one operator family, multiple operator families, or a hybrid operator constructed from multiple operators, provided that the resulting collapse operator(s) are Hermitian and dimensionless as implemented.

In some embodiments, C_hat corresponds to a normalized position operator. For example, a physical position operator x_hat may be normalized by a fixed reference length lambda_ref to form: C_hat=x_hat/lambda_ref.

In some embodiments, lambda_ref is selected as a fixed reference scale associated with a recognition-physics reference length, a device geometry scale, an interferometer path scale, or another fixed length used for consistent normalization. In such embodiments, the collapse contribution suppresses spatial coherences in the eigenbasis of position, with the strength of suppression determined by epsilon and by the scaling embodied in C_hat.

In some embodiments, C_hat corresponds to a normalized momentum operator p_hat normalized by a fixed reference momentum p_ref: C_hat=p_hat/p_ref.

Momentum-based collapse channels may be used in embodiments modeling momentum decoherence, scattering-like collapse channels, and/or measurement channels in which momentum is the relevant pointer observable.

In some embodiments, C_hat corresponds to a normalized mass operator M_hat normalized by a fixed reference mass m_ref: C_hat=M_hat/m_ref.

In other embodiments, C_hat corresponds to a mass-density operator or smeared mass-density operator, particularly in embodiments modeling continuous media, extended objects, or field-theoretic collapse channels. In such embodiments, the mass-density operator may be defined over a spatial region and may be smoothed using a kernel function to avoid singularities or to represent finite resolution.

In some embodiments, C_hat corresponds to a number operator n_hat, which is already dimensionless in many standard representations. In photonic embodiments, n_hat may represent photon number in a mode or in a set of modes. In matter-wave embodiments, n_hat may represent occupation number in a mode. Number-operator embodiments are useful in systems where mode occupancy is the natural measurement channel, including the photonic QRNG embodiment described above.

In some embodiments, C_hat corresponds to a spin-projection operator, such as S_z or a normalized total spin projection. In such embodiments, the collapse term suppresses coherence between different spin-projection eigenstates. Spin-based collapse operators may be useful for GHZ-state, spin-cat, or magnetometry-related embodiments.

In some embodiments, C_hat corresponds to an energy-related operator, which may be H itself normalized by a fixed energy scale E_ref: C_hat=H/E_ref.

In such embodiments, the collapse channel may act as an energy-dephasing channel. In some embodiments, energy-channel collapse operators are used in benchmarking or decoherence modeling contexts.

In some embodiments, C_hat corresponds to a charge operator, a number-difference operator, or another Hermitian operator related to charge or current distribution in a device. Such operators may be used in superconducting qubit embodiments, condensed matter embodiments, and sensor embodiments.

In some embodiments, C_hat corresponds to a field operator, such as an electric-field operator E_hat, a magnetic-field operator, or another Hermitian field operator, optionally smeared over a region by a kernel. Such operators may be used in lattice-QFT embodiments, Schwinger-model embodiments, and other field-theoretic embodiments.

In photonic embodiments, including the QRNG embodiment of FIG. 7, C_hat may correspond to photon-number operators, mode-occupancy operators, number-difference operators, polarization operators, or other Hermitian operators that correspond to distinguishable detection outcomes. In such embodiments, the collapse operator is chosen to align with the measurement channel that produces discrete detection events, enabling mapping of outcomes to random bits.

In some embodiments, a single collapse operator C_hat is used. In other embodiments, multiple collapse operators are used, including cases where multiple collapse channels are modeled simultaneously. In multi-operator embodiments, the total collapse contribution may be expressed as a sum of double-commutator terms: d rho/d t8 =−i [H, rho]−sum_k epsilon_k [C_hat_k, [C_hat_k, rho]].

In some embodiments, each epsilon_k is equal to the same fixed epsilon value disclosed herein, such that epsilon remains universal across collapse channels while different C_hat_k represent different measurement or decoherence channels. In other embodiments, a subset of channels may be enabled or disabled based on the system being modeled, while maintaining the fixed-epsilon foundation for enabled channels.

In various embodiments, the operator families described herein may be implemented in dense, sparse, structured, factorized, or compiled forms. In accelerator embodiments, operators may be stored in device memory and used through batched or streamed multiplication operations. In ASIC embodiments, operator representations may be stored in on-chip memory 504 or streamed through input interface 502 and used in pipelined multiplier paths such as the C_hat squared multiplier path 510 and the C_hat rho C_hat path 512. In some embodiments, an operator library is used to select among operator families and to ensure consistent normalization across deployments.

The operator families and normalization strategies described in this section are exemplary and do not limit the scope of the invention. Any Hermitian, dimensionless collapse operator consistent with the disclosed objective-collapse master equation and fixed-epsilon framework may be used.

The disclosed objective-collapse systems and methods may operate on different representations of quantum state and may accept different classes of inputs depending on the intended application, the selected solver embodiment, the selected hardware embodiment, and the resource constraints of the deployment environment. This section describes representative state representations and the inputs that may be received and processed by the objective-collapse system 100 (FIG. 1), the collapse engine 200 (FIG. 2), the solver workflow 300 (FIG. 3), the Trotter integrator 400 (FIG. 4), the ASIC 500 (FIG. 5), the control system 600 (FIG. 6), the photonic system 700 (FIG. 7), and the cloud simulation service 800 (FIG. 8).

In many embodiments, the quantum state is represented as a density matrix rho. The density matrix representation can represent pure states, mixed states, and ensemble states, and is compatible with Lindblad-form and double-commutator-form evolution. In density-matrix embodiments, rho is evolved according to the objective-collapse master equation described above, for example: d rho/d t8=−i [H, rho]−epsilon [C_hat, [C_hat, rho]].

In such embodiments, rho may be represented as a complex-valued matrix of dimension n×n, where n is the Hilbert-space dimension of the represented system. In some embodiments, rho is Hermitian and positive semidefinite and has trace one.

In some embodiments, the state initialization module 114 (FIG. 1) receives an initial density matrix rho0. The initial density matrix rho0 may be provided explicitly, may be constructed from a mixture of pure states, may be constructed from a thermal state, may be constructed from a reduced state obtained by partial trace of a larger state, or may be constructed from measurement-estimation output. In some embodiments, rho0 is prepared as: rho0=|psi0><psi0| for an initial state vector psi0, and in other embodiments rho0 is prepared as a convex combination: rho0=sum_j w_j|psi_j><psi_j| where weights w_j are nonnegative and sum to one.

In some embodiments, the objective-collapse systems and methods operate on a reduced-sector density matrix or a compressed state representation. Such embodiments are useful when the full Hilbert space is extremely large and the system dynamics of interest lie in a smaller effective subspace. For example, in some embodiments symmetry constraints, conserved quantities, sector decomposition, truncation rules, or basis-selection rules reduce the effective dimension of the represented state.

In reduced-sector embodiments, rho may represent a reduced density matrix for a sector of the full system. In such embodiments, the Hamiltonian H and collapse operators C_hat are represented in the same reduced sector, and the master equation is applied in that reduced representation. In some embodiments, the reduced-sector representation is chosen so that the collapse channel is still meaningfully represented, including that C_hat remains Hermitian and dimensionless within the reduced representation. In some embodiments, the reduced-sector representation supports accelerated computation on GPUs, ASICs, or cloud compute resources by reducing required memory bandwidth and arithmetic operations.

In compressed embodiments, rho may be stored using a compressed representation such as a low-rank approximation, a tensor-network representation, a sparse representation, a block-diagonal representation, a banded representation, or another structured form. In such embodiments, the solver workflow 300 (FIG. 3) may include additional preprocessing to manage compression, including rank management, truncation thresholds, or structure-preserving multiplication kernels. In some embodiments, compressed representations are used primarily for large-dimension simulation, while smaller-dimension simulation uses full dense rho.

In some embodiments, the objective-collapse dynamics are implemented using a state-vector representation psi rather than a density matrix rho, such as in stochastic unravelling embodiments. In such embodiments, each trajectory evolves a state vector psi under an update rule that includes both deterministic drift and stochastic noise increments, and ensemble averaging over many trajectories recovers a density-matrix behavior consistent with the master equation.

In some embodiments, state-vector embodiments are used to reduce memory cost. For an n-dimensional state, a density matrix requires O(n\hat{ }2) storage, while a state vector requires O(n) storage. Accordingly, in certain large-dimension contexts, trajectory methods can be more practical provided that sufficient trajectories are simulated to obtain desired statistical accuracy.

Trajectory embodiments may be used in connection with the photonic system 700 for QRNG, in connection with validation tasks, or in connection with applications where a state-vector description is more natural. Trajectory embodiments are described in further detail in a later section addressing stochastic unravelling.

In various embodiments, the objective-collapse system receives a Hamiltonian H as an input. The Hamiltonian H may represent the intrinsic evolution of the system and/or may incorporate effective dynamics, control terms, or interaction terms. In some embodiments, H is time-independent during a simulation interval. In other embodiments, H is time-dependent, such as H(t8) or H(t), and may incorporate control waveforms or time-varying couplings.

H may be provided in a dense matrix form, sparse matrix form, structured form, factorized form, parameterized model form, or other representation. In some embodiments, the Hamiltonian input module 108 stores H in the Hamiltonian cache 304 (FIG. 3). In some embodiments, the commutator engine 508 (FIG. 5) computes H rho and rho H to form−i[H, rho]. In some embodiments, the unitary propagator U 404 (FIG. 4) is derived from H using an exponential or approximation.

In some embodiments, the input parser 302 (FIG. 3) validates that H is Hermitian (H =H\hat{ }dagger) within numerical tolerances. In some embodiments, when H includes small numerical asymmetries, the input parser 302 symmetrizes H as (H+H\hat{ }dagger)/2.

In various embodiments, the objective-collapse system receives one or more collapse operators C_hat as inputs. As described above, C_hat is Hermitian and dimensionless and may be selected from a variety of operator families including normalized position operators, mass operators, number operators, spin projection operators, energy operators, field operators, charge operators, and photon-number operators.

In some embodiments, a single collapse operator is used. In other embodiments, multiple collapse operators are used to represent multiple collapse channels, multiple measurement channels, or multi-operator collapse formulations. In such embodiments, the collapse-operator input module 110 stores the operator(s) in the collapse-operator cache 306 (FIG. 3), and may store associated metadata including normalization constants C0, operator family identifiers, and/or kernel representations.

In some embodiments, the input parser 302 validates that each C_hat is Hermitian within numerical tolerances and that each C_hat is dimensionless as represented. In some embodiments, an operator normalization step is performed to compute C_hat from a physical operator C using C_hat=C/C0, as described above.

In various embodiments, the objective-collapse system receives a time range and a time resolution specification. In some embodiments, time is expressed in t8 units. In other embodiments, time is expressed in SI time t. In some embodiments, the solver workflow 300 uses tau0 and tau8 to convert between t8 and SI time and uses gamma=epsilon/tau8 to express the collapse strength in SI units, while preserving epsilon as fixed.

Accordingly, in some embodiments, the objective-collapse system receives or accesses a calibration anchor tau 0 (seconds per tick), and computes tau 8=8*tau 0. In some embodiments, tau0 is provided as part of configuration metadata associated with a particular deployment or reporting standard. In some embodiments, tau0 is not adjusted as a collapse-model fitting parameter but is used solely as a reporting and unit-bridging constant between a recognition-time representation and SI units.

In some embodiments, the timestep controller 314 (FIG. 3) receives a fixed timestep dt8 or dt. In other embodiments, the timestep controller 314 receives an error tolerance and implements adaptive step sizing using the error estimator 316.

In various embodiments, the objective-collapse system receives or accesses definitions of one or more observables O for which expectation values are computed. In some embodiments, observables are provided as matrices or operator representations. In some embodiments, observables are provided as names mapped to operator definitions in an operator library. In some embodiments, the observables engine 118 (FIG. 1) and observable calculator 320 (FIG. 3) compute expectation values=Tr(rho O) and provide such values to outputs or control loops.

In some embodiments, the objective-collapse system receives output configuration specifying whether to output full state histories, sampled states, observables only, summary metrics only, reports, certificates, logs, or combinations thereof. In some embodiments, the output formatter 322 (FIG. 3) and response generator 818 (FIG. 8) generate outputs accordingly.

In control embodiments, such as the control system 600 of FIG. 6, the objective-collapse system receives additional inputs including measured observable values (measured observable input 606) and target values (target observable input 608). In some embodiments, control gains or control law parameters are also provided, such as K_p for proportional control. In some embodiments, the control system operates with timing constraints monitored by the loop timing monitor 622, and may also receive configuration constraints including maximum latency, maximum update interval, or permissible control parameter ranges.

In cloud embodiments, such as the cloud simulation service 800 of FIG. 8, inputs may be provided through the API gateway 804 and parsed by the request parser 806. In such embodiments, inputs may include H, C_hat, rho0 or psi0, time ranges, solver configuration, and output selection. In some embodiments, authentication tokens and usage limits are also provided and processed by the authentication block 820 and accounting block 822.

In various embodiments, the objective-collapse system validates inputs for correctness and numerical stability. Such validation may include checking dimensions, checking Hermiticity, checking trace and positivity of rho0, checking normalization of collapse operators, checking time-range and timestep settings, and checking compatibility between chosen solver strategies and operator representations. In some embodiments, invalid inputs produce explicit errors, warnings, or fallback behaviors such as reduced timestep selection. In some embodiments, inputs are modified to enforce structural properties, such as symmetrizing operators to enforce Hermiticity, provided such modifications are consistent with the modeled system.

The state representations and input types described herein are exemplary and do not limit the scope of the invention. Any representation and input arrangement that enables objective-collapse evolution under a fixed epsilon in accordance with the disclosed master equation may be used.

This section describes deterministic solver embodiments that evolve a quantum state representation rho under the disclosed objective-collapse master equation using a density-matrix formulation. Deterministic embodiments are useful for producing reproducible ensemble-average predictions, for benchmarking and validation, and for control applications where a stable state estimate and predictable evolution are desired. In various embodiments, the deterministic solver core is implemented by the solver core 116 of FIG. 1 and executes the solver workflow 300 of FIG. 3 while using the collapse engine 200 of FIG. 2 to compute derivatives and state updates. Portions of the deterministic solver core may be accelerated by specialized compute resources, including the ASIC 500 of FIG. 5 and cloud compute resources of FIG. 8.

In exemplary embodiments, the deterministic solver core evolves rho according to the objective-collapse master equation expressed in plain-text form as: d rho/d t8=−i [H, rho]−epsilon [C_hat, [C_hat, rho]] where H is a Hamiltonian or effective Hamiltonian and C_hat is a Hermitian, dimensionless collapse operator. In embodiments using SI time t, the evolution may be expressed as: d rho/d t=−i [H, rho]−gamma [C_hat, [C_hat, rho]] where gamma=epsilon/tau8 and tau8=8*tau0 as described above.

In various embodiments, the deterministic solver core evaluates the commutator and double-commutator contributions using matrix multiplications and additions. In embodiments using the expanded form of the double commutator, the collapse contribution is computed using: [C_hat, [C_hat, rho]]=C_hat\hat{ }2 rho−2 C_hat rho C_hat +rho C_hat\hat{ }2.

Accordingly, the deterministic solver core may compute and cache C_hat\hat{ }2, compute intermediate products including H rho, rho H, C_hat\hat{ }2 rho, rho C_hat\hat{ }2, and C_hat rho C_hat, and assemble the derivative using linear combinations of such intermediate products.

In embodiments using the Lindblad-form representation, the deterministic solver core may implement the equivalent form: d rho/d t8=−i [H, rho] +2*epsilon*(C_hat rho C_hat−(1/2) {C_hat\hat{ }2, rho}) with L=sqrt(2*epsilon)*C_hat as an associated Lindblad operator. In such embodiments, the deterministic solver core may select whichever representation is more computationally efficient or more convenient for numerical stability checking, provided that the implemented evolution remains consistent with the disclosed objective-collapse dynamics.

In various embodiments, the deterministic solver core performs a time-stepping loop that includes the following sequence of operations, which may be implemented as software instructions, hardware logic, or combinations thereof:

Receive or access inputs. The deterministic solver core receives or accesses the Hamiltonian H, one or more collapse operators C_hat, the fixed epsilon value, an initial density matrix rho0, a time range, and one or more solver configuration parameters, including a timestep policy and output requests.

Precompute reusable operator quantities. The deterministic solver core precomputes one or more reusable quantities, including without limitation C_hat\hat{ }2 and, in some embodiments, a propagator U(dt8)=exp(−i H dt8) or eigenstructures usable for split-step evolution. In multi-operator embodiments, the deterministic solver core may precompute C_hat_k\hat{ }2 for each operator C_hat_k.

Construct or select derivative evaluation structures. The deterministic solver core constructs or selects evaluation pathways such as commutator evaluation structures for −i[H, rho] and collapse evaluation structures for −epsilon[C_hat, [C_hat, rho]]. In some embodiments, the deterministic solver core constructs compiled kernels or uses linear algebra libraries to compute required matrix multiplications.

Evaluate the state derivative. For a current state rho_n at a current time, the deterministic solver core evaluates a derivative term d rho/d t8 (or d rho/d t) according to the chosen representation (expanded double commutator, Lindblad form, or equivalent). In some embodiments, the derivative evaluation is performed by the collapse engine 200, and intermediate results are stored in working buffers.

Integrate to produce an updated state. The deterministic solver core uses a numerical integration step to compute an updated state rho_{n+1} from rho_n and the derivative evaluation. In some embodiments, the integration is performed using an explicit integrator such as Runge-Kutta, an implicit or semi-implicit integrator, a split-step integrator such as the Trotter integrator 400, or another stable integration scheme.

Apply normalization and validity maintenance procedures. In some embodiments, the deterministic solver core applies trace correction to enforce Tr(rho)=1 within numerical tolerances. In some embodiments, additional validity maintenance procedures are applied, including Hermiticity enforcement via symmetrization and positivity maintenance procedures suitable for the selected integrator and numeric precision.

Compute and output observables and metrics. In some embodiments, the deterministic solver core computes one or more expectation values=Tr(rho O), state metrics, and/or derived outputs, and provides outputs to an output formatter, to a control loop, or to a cloud service response.

Repeat until completion. The deterministic solver core repeats the derivative evaluation and integration steps until an end time is reached, or until a stopping condition is satisfied, such as convergence, threshold crossing, a control objective, or resource limits.

This sequence may be performed for a single simulation job, a batch of jobs, or a continuous control-loop execution depending on the deployment.

In exact arithmetic, the disclosed objective-collapse master equation in double-commutator form is trace preserving. In finite precision arithmetic, numerical drift may occur. Accordingly, in various embodiments, the deterministic solver core monitors and/or enforces state validity properties, including without limitation:

Trace monitoring: computing Tr(rho) and detecting deviations from unity.

Hermiticity monitoring: checking that rho=rho\hat{ }dagger within tolerance.

Positivity monitoring: checking that rho has nonnegative eigenvalues within tolerance or using positivity-preserving update structures.

Purity monitoring: computing Tr(rho\hat{ }2) to track coherence decay and to detect unexpected numerical artifacts.

In some embodiments, the solver performs periodic trace renormalization by scaling rho so that Tr(rho)=1. In some embodiments, the solver enforces Hermiticity by replacing rho with (rho+rho\hat{ }dagger)/2. In some embodiments, positivity is maintained by selecting integrators and time steps that preserve complete positivity, including by implementing Lindblad-form evolution and/or by using split-step updates that preserve state validity within tolerances.

The deterministic solver core may also compute diagnostic quantities, including norms of commutator and collapse terms, error estimates for adaptive step selection, and performance metrics such as runtime per step and memory utilization.

In some deterministic embodiments, multiple collapse operators are used. In such embodiments, the collapse contribution may be assembled as a sum of double-commutator terms. In an exemplary embodiment: d rho/d t8=−i [H, rho]−sum_k epsilon_k [C_hat_k, [C_hat_k, rho]].

In some embodiments, each epsilon_k is equal to the same fixed epsilon disclosed herein, while different C_hat_k represent different collapse channels. In such embodiments, the deterministic solver core evaluates each channel's double commutator and sums the contributions prior to integration.

Deterministic solver outputs may include a time series of rho values, sampled rho values at requested intervals, time series of expectation values, computed decoherence metrics, state-validity logs, benchmark logs, and/or reports. In control embodiments, deterministic outputs may include predicted observables used to compute control errors and generate actuation signals. In cloud embodiments, deterministic outputs may be packaged as downloadable reports or API responses.

Deterministic embodiments are not limited to any specific integrator, numerical precision, or compute platform. Any deterministic scheme that computes the disclosed objective-collapse evolution under fixed epsilon and produces valid state outputs may be used.

In some embodiments, the deterministic solver core described above is implemented using one or more Runge-Kutta integration methods. Runge-Kutta methods are useful because they provide stable, well-understood accuracy properties and can be implemented in a modular manner using repeated derivative evaluations. In various embodiments, a Runge-Kutta method is applied to evolve a density matrix rho under the disclosed objective-collapse master equation, using derivative evaluations provided by the collapse engine 200 (FIG. 2) and workflow management provided by the solver workflow 300 (FIG. 3).

In one exemplary embodiment, the solver implements a classical fourth-order Runge-Kutta method (RK4) using a fixed timestep dt8 (or dt in SI time). For clarity, the RK4 method is described below in terms of an evolution variable s, which may correspond to t8 or to SI time t depending on the selected time representation.

Let F(rho, s) denote the right-hand side of the master equation, i.e., the derivative function that maps a current state rho and time s to a derivative d rho/d s. In exemplary embodiments, F is defined by: F(rho, t8)=−i [H, rho]−epsilon [C_hat, [C_hat, rho]] or in SI-time embodiments: F(rho, t)=−i [H, rho]−gamma [C_hat, [C_hat, rho]] with gamma=epsilon/tau8.

Given a current state rho_n at time s_n and a timestep ds, the RK4 embodiment computes:

k1=F(rho_n, s_n)

k2=F(rho_n +(ds/2)*k1, s_n+ds/2)

k3=F(rho_n+(ds/2)*k2, s_n+ds/2)

k4=F(rho_n+ds*k3, s_n+ds)

and then updates the state as: rho_{n+1}=rho_n+(ds/6)*(k1+2k2+2k 3+k4).

In various embodiments, each evaluation of F(rho, s) is performed using matrix multiplications and combinations consistent with the commutator and double-commutator structure described above. In some embodiments, the solver uses cached operator quantities such as C_hat\hat{ }2 (stored in the C_hat squared cache 308) to reduce repeated computation within each derivative evaluation.

In some embodiments, the solver implements adaptive step sizing using an embedded Runge-Kutta pair. In such embodiments, the solver computes both a higher-order and lower-order estimate of rho_{n+1} over the same step, estimates a local truncation error based on the difference between those estimates, and adjusts the timestep ds to meet a target tolerance.

In one exemplary adaptive embodiment, the solver performs the following operations for each proposed step:
(1) compute candidate updates rho_{n+1}\hat{ }{(high)} and rho_{n+1}\hat{ }{(low)} using an embedded Runge-Kutta pair;
(2) compute an error estimate err =norm(rho_{n+1}\hat{ }{(high)}−rho_{n+1}\hat{ }{(low)});
(3) compare err to a tolerance tol;
(4) accept the step if err<=tol and set rho_{n+1}=rho_{n+1}\hat{ }{(high)};
(5) adjust the next step size ds_next using a step control law, for example: ds_next=ds*(tol/err)\hat{ }(1/p) where p is an exponent related to the order of the method, subject to minimum and maximum step-size limits.

Adaptive step sizing can be beneficial when the collapse term becomes stiff for certain operator norms or when the Hamiltonian term introduces rapid oscillations requiring smaller steps for accuracy. Adaptive step sizing can also be beneficial in control applications where time resolution is dynamically adjusted based on observed stability or error.

Because Runge-Kutta methods are explicit and operate in finite precision arithmetic, some embodiments include additional state validity maintenance steps to ensure rho remains a valid density matrix within numerical tolerances. Such steps may include:
Trace maintenance: computing Tr(rho) after each step and applying normalization if Tr(rho) deviates from unity beyond a tolerance;
Hermiticity enforcement: replacing rho with (rho+rho\hat{ }dagger)/2 after a step or periodically;
Positivity monitoring: checking eigenvalues or using other positivity checks, and adjusting ds if violations are detected.

In some embodiments, when positivity violations are detected, the solver reduces the step size ds and recomputes the step. In some embodiments, positivity maintenance is achieved by selecting sufficiently small ds and by using formulations that preserve complete positivity, such as implementations that rely on Lindblad-form structure and operator-splitting.

In various embodiments, RK-based solvers are implemented using CPU linear algebra libraries, GPU linear algebra libraries, or dedicated hardware acceleration. In some embodiments, the right-hand side evaluation F(rho, s) is implemented using a fixed set of matrix multiplications per derivative evaluation, and those multiplications are accelerated using batched GEMM calls, fused kernels, or pipeline datapaths. In some embodiments, the solver performs checkpointing and stores periodic state snapshots in the state history store 326 (FIG. 3). In some embodiments, the solver performs observables computation at a different sampling rate than the integration step size, thereby reducing output overhead.

Runge-Kutta embodiments described herein are exemplary and non-limiting. Any Runge-Kutta method, including higher-order explicit methods, implicit methods, semi-implicit methods, and embedded adaptive methods, may be used to integrate the disclosed objective-collapse master equation, provided that epsilon remains fixed and the implemented evolution is consistent with the disclosed collapse dynamics.

In some embodiments, the objective-collapse dynamics disclosed herein are implemented using stochastic unravelling (also referred to as quantum trajectory) techniques. In such embodiments, individual realizations of a collapse process are represented as stochastic trajectories of a state vector psi (or, in some embodiments, as stochastic trajectories of a reduced state representation), and ensemble averaging over many trajectories yields a density-matrix evolution consistent with the objective-collapse master equation described above. Stochastic unravelling embodiments can be useful for reducing memory cost relative to full density-matrix simulation, for modeling single-run experimental outcomes, for generating random outcomes in a controlled manner, and for implementing certain real-time or distributed simulation strategies.

In various embodiments, the density-matrix master equation: d rho/d t8=−i [H, rho]−epsilon [C_hat, [C_hat, rho]] (or its Lindblad-form equivalent) is treated as an ensemble-average evolution, while individual outcomes are represented by stochastic trajectories. In such embodiments, the trajectory simulator evolves a state vector psi under a stochastic update rule that includes deterministic drift associated with H and collapse-related drift and noise terms associated with C_hat and epsilon.

In some embodiments, the stochastic unravelling is selected to be consistent with a Lindblad operator: L=sqrt(2*epsilon)*C_hat so that the ensemble average of the trajectories reproduces the Lindblad-form evolution corresponding to the double-commutator dissipator when C_hat is Hermitian.

In one exemplary embodiment, a trajectory update is expressed in plain-text form as: |psi(t8+dt8)>proportional to (1−i H dt8−epsilon C_hat\hat{ }2 dt8)|psi(t8)>+sqrt(2*epsilon*dt8)*C_hat|psi(t8)>*dW where dW is a stochastic increment (for example, a Wiener increment) and where the resulting state is normalized after the update. This form is exemplary and non-limiting; other unravellings may be used, including jump unravellings and diffusive unravellings, provided that the ensemble-level evolution remains consistent with the disclosed objective-collapse dynamics.

In some embodiments, the proportionality reflects a normalization step. After computing an unnormalized intermediate vector: |psi_tilde>=(1−i H dt8−epsilon C_hat\hat{ }2 dt8)|psi>+sqrt(2*epsilon*dt8)*C_hat |psi>*dW the updated normalized state is computed as: |psi_next>=|psi_tilde>/sqrt(<psi_tilde|psi_tilde>).

Normalization may be performed each step or periodically depending on stability targets.

In SI-time embodiments, the same update may be expressed using gamma =epsilon/tau8, with dt in seconds replacing dt8, while epsilon remains fixed and only the time scaling changes through tau8.

In some embodiments, the stochastic increment dW is generated using a pseudo-random number generator seeded by a seed value for reproducibility. In other embodiments, dW is generated using a hardware entropy source, including a QRNG source such as the photonic system 700 described above, or another entropy source. In some embodiments, a random-seed manager stores seeds, stream identifiers, and/or generator configuration so that trajectories can be reproduced for debugging and verification.

In some embodiments, when stochastic unravelling is used for scientific prediction, a large number of trajectories are simulated and averaged to reduce statistical error. In such embodiments, the number of trajectories and confidence intervals may be included in outputs and reports.

In stochastic unravelling embodiments, ensemble-level density-matrix behavior may be reconstructed by averaging outer products: rho(t) approximately equals (1/N)*sum_j|psi_j(t)><psi_j(t)|where j indexes trajectories and N is the number of trajectories.

In some embodiments, observables are estimated directly from trajectories without explicitly reconstructing rho, for example by computing: (t) approximately equals (1/N)*sum_j<psi_j(t)|O|psi_j(t)>.

Such direct estimation can reduce memory usage and can be more efficient when only a subset of observables is required rather than the full state.

Stochastic unravelling embodiments can reduce memory cost from O(n\hat{ }2) to O(n) per trajectory for an n-dimensional Hilbert space. In large-dimension contexts, this can allow simulation of systems that are impractical to simulate using full density matrices, at the cost of requiring multiple trajectories to achieve low-variance estimates.

In some embodiments, trajectories are embarrassingly parallel and can be distributed across compute nodes, GPU resources, or cloud resources. In such embodiments, each worker simulates a subset of trajectories and returns partial averages, which are combined by an aggregator.

In real-time contexts, stochastic unravelling can be used to generate representative collapse outcomes or to approximate decoherence effects in a computationally constrained setting, provided that the number of trajectories and update rate satisfy timing requirements.

In some embodiments, stochastic unravelling is used as part of a random-value generation pathway. For example, one or more trajectory outcomes can be mapped to discrete events, including threshold crossings, sign outcomes, detector-outcome mappings, or mode-occupancy outcomes. In the photonic QRNG embodiment described above, detection events are mapped to bit values; in other embodiments, simulated or measured collapse outcomes can likewise be mapped to bits.

Any randomness extraction described herein is exemplary and non-limiting. Practical deployments may include health tests, bias correction, and entropy estimation procedures as described above with respect to the photonic system 700.

Stochastic unravelling embodiments described herein are exemplary. In other embodiments, jump-type unravellings are used, including discrete collapse “jumps” occurring at stochastic times. In other embodiments, diffusive unravellings are used. In some embodiments, the unravelling is selected to match an experimental measurement record model. In some embodiments, the solver switches between deterministic density-matrix evolution and stochastic trajectory evolution based on resource constraints or output requirements.

In all cases, epsilon remains fixed as disclosed herein, and the stochastic trajectory evolution is configured so that ensemble behavior is consistent with the disclosed objective-collapse master equation and its equivalent Lindblad-form expression for Hermitian collapse operators.

In various embodiments, the objective-collapse dynamics disclosed herein are extended beyond a single-collapse-operator, nonrelativistic setting to include (i) multiple collapse operators representing multiple collapse channels, (ii) relativistic parameterizations and proper-time evolution for certain modeled systems, and (iii) field-theoretic and lattice-based embodiments in which the collapse operator corresponds to a smeared field observable (e.g., mass-density, electric field, or other Hermitian field observables). These embodiments are useful for broad applicability, including modeling complex devices with multiple decoherence channels, modeling field-theoretic systems and lattice gauge theories, and providing validation pathways across different physical regimes, while preserving the fixed-epsilon foundation and avoiding user-tuned collapse-rate parameters.

In some embodiments, the objective-collapse evolution uses multiple collapse operators {C_hat_k}. Each operator C_hat_k represents a collapse channel or measurement-like channel associated with a corresponding physical observable, device coupling, or modeling abstraction. In such embodiments, the master equation includes a sum of double-commutator terms, expressed in plain-text form as: d rho/d t8=−i [H, rho]−sum_k epsilon_k [C_hat_k, [C_hat_k, rho]].

In some embodiments, each epsilon_k is set equal to the same fixed epsilon value disclosed herein, such that each collapse channel shares a universal collapse strength and the only channel-specific content is contained in the operator C_hat_k itself. In such embodiments, the evolution may be expressed as: d rho/d t8=−i [H, rho]−epsilon*sum_k [C_hat_k, [C_hat_k, rho]].

This formulation is useful where multiple physical channels are simultaneously present, including without limitation position-like channels, number/occupation channels, spin channels, charge channels, energy channels, and field channels, as described above in the operator-family section.

In some embodiments, different collapse channels are enabled or disabled based on the device being modeled, a configuration selection, or a simulation mode. For example, a superconducting-qubit modeling embodiment may include a charge-related collapse operator and a number-related collapse operator, while a trapped-ion embodiment may include a position-related collapse operator and a spin-related collapse operator. In all such embodiments, epsilon remains fixed and is not used as a user-selected fitting parameter to tune collapse strength for a particular device.

In some embodiments, the collapse operators may be combined into a single effective operator, for example by a weighted sum: C_hat_eff=sum_k a_k*C_hat_k where coefficients a_k are selected for a particular modeling purpose. In such embodiments, the collapse term may be implemented using C_hat_eff as the collapse operator, provided C_hat_eff remains Hermitian and dimensionless. This effective-operator embodiment can simplify computation in some deployments but does not limit the invention to any particular operator combination method.

In some embodiments, multi-operator collapse is implemented using a multi-operator Lindblad representation. For example, when each C_hat_k is Hermitian, each channel corresponds to a Lindblad operator: L_k=sqrt(2*epsilon_k)*C_hat_k and the evolution may be represented as: d rho/d t8=−i [H, rho] +sum_k 2*epsilon_k*(C_hat_k rho C_hat_k−(1/2){C_hat_k\hat{ }2, rho}).

In embodiments where each epsilon_k equals the same fixed epsilon, the coefficient remains fixed across channels. This representation may be useful to emphasize complete positivity and trace preservation and to support certain integrator implementations and validity checks.

In some embodiments, the objective-collapse evolution is parameterized using a time variable that is not necessarily laboratory coordinate time. For example, in certain relativistic modeling settings, evolution may be parameterized by a proper-time variable s (or another invariant parameter) associated with a worldline or a chosen foliation. In such embodiments, the master equation may be expressed with respect to s: d rho/d s =−i [H_s, rho]-epsilon [C_hat, [C_hat, rho]] where H_s denotes a generator appropriate to the chosen parameterization. In SI-time reporting embodiments, conversion from the chosen parameterization to SI time may still be provided through an external calibration seam, while epsilon remains fixed.

In some embodiments, relativistic parameterization is applied in a practical, simulation-oriented manner, such as by (i) selecting a discretized time parameter for numerical integration, (ii) selecting a Hamiltonian-like generator consistent with a relativistic model (e.g., effective Hamiltonians for relativistic regimes), and (iii) selecting collapse operators corresponding to relativistically meaningful observables (e.g., smeared field observables). Such embodiments are not limited to any one relativistic formalism and are intended to cover practical simulation and modeling deployments where relativistic considerations are relevant.

In some embodiments, the objective-collapse evolution is applied to field-theoretic systems, including lattice-discretized quantum field theories. In such embodiments, the state rho may represent a field-theoretic density matrix over a discretized Hilbert space (for example, a lattice basis), and H may represent a field-theoretic Hamiltonian or effective generator in that discretized representation.

In such embodiments, the collapse operator C_hat may correspond to a Hermitian, dimensionless field observable, including without limitation: a smeared mass-density operator, an electric-field operator (e.g., a lattice electric field), a magnetic-field operator, a charge-density operator, a number/occupation operator at lattice sites, or another Hermitian field observable suitable for collapse-channel modeling.

In some embodiments, a smearing kernel is used to define a smeared operator over a region rather than a point-like operator, for example: C_hat=integral_over_space K(x, x0)*F_hat(x) dx/C0 where F_hat(x) is a Hermitian field observable, K(x, x0) is a kernel defining a smearing or resolution function, and C0 normalizes the operator to a dimensionless form. In lattice embodiments, the integral may be replaced by a sum over lattice sites and the kernel may be represented as a finite set of weights. Smearing can be used to represent finite resolution, to avoid singular behavior, and to model collapse channels that act on coarse-grained observables.

In some embodiments, lattice gauge theory embodiments use collapse operators that correspond to lattice link variables, plaquette observables, or electric-field link operators, while maintaining Hermiticity and dimensionless normalization. In such embodiments, the objective-collapse dynamics can be used to study decoherence-like behavior, collapse-induced damping of off-diagonal coherence in selected bases, and changes in observable statistics under collapse dynamics.

Field-theoretic and lattice embodiments may involve large Hilbert spaces. Accordingly, in some embodiments the solver uses reduced-sector representations, symmetry reductions, truncations, or compressed representations as described above. In some embodiments, split-step methods (such as the Trotter integrator 400) are used, including by applying unitary propagators derived from lattice Hamiltonians and collapse updates derived from operator eigenstructures when appropriate. In some embodiments, stochastic unravelling is used to reduce memory cost.

In some embodiments, the objective-collapse simulation outputs are used to evaluate validation metrics such as approximate conservation of selected quantities (where applicable), convergence versus timestep selection, stability of trace and positivity, and reproducibility across compute platforms. Any such validation metrics are exemplary and not limiting.

The multi-operator, relativistic, and field-theoretic embodiments described in this section are intended to illustrate that the disclosed objective-collapse framework is not limited to a single collapse operator, a single device class, or a single nonrelativistic system type. In all embodiments, the collapse strength epsilon remains fixed as disclosed herein, and any conversion to SI time for reporting purposes is performed through an external calibration seam rather than by introducing adjustable collapse-rate parameters.

The embodiments described herein are exemplary and are provided to illustrate practical implementations of objective-collapse state evolution using a fixed collapse strength epsilon. This section describes non-limiting variations, implementation alternatives, and combinations that may be used to implement the disclosed objective-collapse dynamics across different compute platforms, deployment environments, and application contexts, without departing from the scope of the invention as defined by the claims. Unless expressly stated otherwise, any feature described with respect to one embodiment may be combined with any feature described with respect to another embodiment, provided the resulting combination is technically feasible.

In various embodiments, the objective-collapse system is implemented using one or more of the following compute platforms: general-purpose processors executing software instructions stored in memory (e.g., processor 104 and memory 106); graphics processing units (e.g., GPU resources used by the GPU cluster 810); reconfigurable logic devices (e.g., FPGA-based embodiments, including as a controller co-processor or accelerator); application-specific integrated circuits (e.g., ASIC 500); integrated photonic circuits and photonic subsystems (e.g., photonic system 700); cloud-based clusters and containerized compute environments (e.g., cloud simulation service 800); and hybrid deployments that combine two or more of the above compute resources.

In some embodiments, the same simulation job may be partitioned across compute resources. For example, a host processor may manage orchestration and I/O while a GPU performs matrix multiplications, and an ASIC co-processor performs repeated double-commutator evaluations for a control loop. In other embodiments, a cloud service schedules some jobs to GPUs and other jobs to CPUs depending on input dimension and requested latency.

In various embodiments, the system uses different numeric representations depending on the deployment. By way of example and without limitation: density matrices and operators may be represented using complex floating-point formats; fixed-point arithmetic may be used in hardware embodiments; mixed precision may be used, such as higher precision for validation runs and lower precision for real-time control runs; block floating-point representations or quantized representations may be used in resource-constrained environments; and intermediate results may be stored at different precisions to manage bandwidth and accuracy.

In some embodiments, epsilon is stored or represented in a manner compatible with the chosen precision mode, including as a compiled constant, a stored constant, or a fused nonvolatile constant. In all embodiments, epsilon remains fixed in the sense that it is not a user-tunable collapse-model fitting parameter.

While the Detailed Description describes split-step (Trotter) and Runge-Kutta embodiments as representative integrator classes, the disclosed systems are not limited to those integrators. In various embodiments, the solver core may implement: explicit integrators (including higher-order Runge-Kutta methods); implicit or semi-implicit integrators for stiff regimes; operator-splitting methods including symmetric splitting; exponential integrators; Krylov-subspace propagation methods; integrators that preserve structural invariants (e.g., trace and Hermiticity) by construction; and hybrid solvers that switch between methods based on stability, error thresholds, or performance constraints.

In some embodiments, the solver selects an integrator dynamically based on observed stability metrics, operator norms, timestep constraints, or real-time control deadlines. In some embodiments, the solver uses deterministic density-matrix evolution for baseline prediction and stochastic unravelling for additional outcome statistics, or vice versa.

In various embodiments, the objective-collapse system outputs one or more of: full state histories rho(t) or sampled states; state vectors psi(t) for trajectory embodiments; expectation values (t)=Tr(rho O) and related statistics; purity Tr(rho\hat{ }2), entropy indicators, coherence measures, or other state metrics; control outputs including voltages, pulse instructions, gate-parameter updates, or actuator commands; random values and/or random bits, including raw bits and whitened bits; entropy estimates and/or health-test reports for randomness generation; benchmark summaries and performance logs; reproducibility packages including configuration metadata and traceability logs; and reports suitable for validation, regulatory documentation, or audit.

Interfaces may include local APIs, network APIs, message queues, streaming interfaces, memory-mapped interfaces, and/or hardware bus interfaces, including those used by the input interface 502 and the actuator interface 618.

In various embodiments, the disclosed objective-collapse evolution is deployed as: a standalone simulation application executed locally; a library linked into a larger simulation or control program; an embedded controller module integrated with quantum hardware; a co-processor or accelerator integrated with a host system; a cloud-based simulation service accessible through an API; an edge-deployed service near a laboratory instrument or quantum device; or a hybrid service in which some computations are local and other computations are remote.

In some embodiments, cloud deployment includes multi-tenant access controls, job scheduling, and usage accounting. In some embodiments, edge deployment is selected to satisfy latency constraints for real-time control loops.

As used herein, epsilon is “fixed” in the sense that it is not selected or tuned as a free collapse-model parameter for fitting or accommodating experimental outcomes. The following implementation variations are expressly contemplated while maintaining a fixed epsilon: storing epsilon as a constant numeric value in software; compiling epsilon into code paths or kernels; storing epsilon in constant memory or read-only memory; fusing epsilon in nonvolatile circuitry (e.g., fixed-epsilon fuse register 506); computing epsilon from its defining formula in software or hardware; and converting between time representations (t8 and SI time) using tau8 and gamma=epsilon/tau8 for reporting purposes.

These variations are consistent with fixed-epsilon embodiments provided the collapse strength epsilon is not treated as a user-tunable collapse parameter.

In various embodiments, the methods, systems, and hardware described with respect to FIG. 1 through FIG. 8 share a common inventive concept: a fixed-epsilon objective-collapse evolution engine that computes a state derivative including a Hamiltonian commutator contribution and a collapse contribution having a double-commutator structure scaled by a fixed collapse strength epsilon, and that produces at least one of an updated state, one or more observables, a control output, a random value/bit output, or a network-accessible simulation result. The different embodiments (software, accelerator, integrated circuit, control-loop, cloud service, and photonic embodiments) are alternative implementations and deployment contexts for the same fixed-epsilon collapse engine and associated solver workflow. Accordingly, features of FIG. 1 through FIG. 8 may be combined in any technically feasible manner. For example, a photonic QRNG embodiment may use the cloud simulation service for certification reports while generating bits locally. A control-loop embodiment may use the ASIC for fast derivative computation while using a host processor for higher-level control policies and safety constraints. A cloud deployment may provide batch simulation for benchmarking and an edge deployment may provide real-time simulation for hardware control.

Any numeric values, timing values, throughput values, process nodes, device names, and platform names described herein are provided as examples of contemplated implementations and validation scenarios. Unless expressly recited in a claim, such values and identifiers are not intended to limit the scope of the invention. The invention is defined by the claims and includes all equivalents thereof.

The disclosed objective-collapse systems and methods provide technical advantages and technical effects in comparison with conventional approaches to quantum-state evolution, measurement modeling, and objective-collapse simulation. The following advantages are provided to describe exemplary technical benefits of the disclosed embodiments and are not intended to limit the scope of the invention unless expressly recited in a claim.

In various embodiments, the disclosed objective-collapse evolution provides a technical improvement in computer-implemented quantum-state simulation and control by enforcing a fixed-collapse-strength objective-collapse generator while providing implementation-level mechanisms that improve numerical stability, reproducibility, and real-time operability. In particular, embodiments described herein (i) compute the collapse contribution using a double-commutator structure and/or an equivalent Lindblad-form representation, (ii) reduce repeated computation by precomputing and caching reusable operator quantities such as C_hat\hat{ }2 and by using compiled kernels or accelerator pathways, (iii) monitor and maintain state validity using trace monitoring and normalization, Hermiticity checks/symmetrization, and positivity monitoring with tolerance-based corrective actions including timestep reduction and step recomputation, and (iv) support bounded-latency operation by using timestep clamping, reduced-precision modes where appropriate, and hardware datapaths (e.g., ASIC pipelines) that accelerate derivative evaluation and integration. These implementation mechanisms yield consistent simulation outputs across compute platforms for the same inputs (H, C_hat, rho0, and time configuration) while avoiding user-tuned collapse-model fitting parameters, and they enable integration into real-time control loops, accelerator deployments, and cloud-service execution as described herein.

The disclosed embodiments are engineered to be implemented as a concrete, operational engine rather than as an abstract model. In various embodiments, the objective-collapse evolution is implemented in software executed by processors, in GPU-accelerated solvers, in dedicated hardware such as ASICs, and/or as a cloud-based simulation service. This implementability enables practical integration with existing quantum-simulation workflows, device-control stacks, benchmarking pipelines, and distributed compute environments. In some embodiments, dedicated hardware implementations can reduce latency and increase throughput in comparison with purely software-based approaches, enabling real-time or near-real-time operation for certain control and monitoring tasks.

In various embodiments, the disclosed objective-collapse term is representable in an equivalent Lindblad form, which can be used to support complete positivity and trace preservation properties when implemented as disclosed herein. This structural compatibility can simplify correctness checking and can support solver designs that maintain density-matrix validity properties such as trace-one normalization and positivity within numerical tolerances. Such properties are practically important for robust simulation, benchmarking, and control, particularly when computations are performed in finite precision and under performance constraints.

The disclosed embodiments support both deterministic density-matrix evolution and stochastic unravelling/trajectory evolution. Deterministic embodiments are useful for reproducible ensemble-average predictions, benchmarking, and control state estimation. Stochastic embodiments can reduce memory cost for large state spaces and can model single-run outcome statistics, including random outcomes used in QRNG-related applications. This flexibility allows a deployment to select solver strategies appropriate to its resource constraints and application objectives while remaining within the fixed-epsilon objective-collapse framework.

In various embodiments, the disclosed systems support real-time feedback-control integration in which simulated or estimated objective-collapse dynamics are used to compute control errors and generate control outputs for quantum hardware. This can provide technical effects including improved stability of target states, compensation for collapse-induced decoherence, adaptive experiment control, and more consistent device operation under measurement and environmental variability. The described closed-loop integration enables the objective-collapse evolution to be used not only for offline simulation but also as a component of operational quantum-control systems.

The disclosed embodiments support a wide range of collapse-operator families, including position-related operators, mass and mass-density operators, number operators, spin operators, energy operators, charge operators, and field operators, as well as multi-operator embodiments. This breadth supports applicability across multiple device types and modeling contexts, including photonic systems, trapped-ion systems, superconducting systems, sensors, and lattice or field-theoretic simulations. This breadth also supports a common collapse framework across different experimental platforms without requiring per-platform collapse-parameter tuning.

Cloud-based embodiments enable objective-collapse simulation to be provided as a scalable service, supporting distributed workflows, batch computation, and integration with remote client devices and laboratories. This deployment model can reduce local compute requirements, centralize validation and reporting pipelines, and provide consistent simulation outputs across teams and environments, while maintaining the fixed-epsilon objective-collapse foundation.

Photonic embodiments provide a pathway for generating random values and random bits using photonic detection events in connection with objective-collapse dynamics. Such embodiments can provide an entropy source usable for cryptographic applications, testing, and security-related deployments. Optional entropy estimation and certification mechanisms can provide additional operational confidence in produced bitstreams, particularly when combined with health tests and traceability logs.

1. A computer-implemented method for objective-collapse quantum-state evolution, comprising:
(a) receiving an initial quantum state representation rho0;
(b) receiving a Hamiltonian H;
(c) receiving a Hermitian, dimensionless collapse operator C_hat;
(d) setting a collapse strength epsilon as a fixed constant defined by: phi=(1+sqrt(5))/2, and epsilon=8*phi/pi;
(e) computing a time derivative of a quantum state rho according to an objective-collapse master equation that includes a unitary commutator term and a collapse term having a double-commutator structure scaled by the collapse strength epsilon;
(f) numerically integrating the objective-collapse master equation over a plurality of timesteps to generate an updated quantum state rho(t); and
(g) outputting at least one of: the updated quantum state rho(t), an observable derived from rho(t), or a report derived from rho(t),
wherein epsilon is not selected or tuned as a user-adjustable collapse-model fitting parameter.

2. The method of claim 1, wherein the objective-collapse master equation is expressed with respect to an eight-tick time variable t8 and includes:
d rho/d t8=−i [H, rho]−epsilon [C_hat, [C_hat, rho]].

3. The method of claim 1, further comprising expressing time in SI units by defining tau8=8*tau0 and gamma=epsilon/tau8, and computing the time derivative with respect to SI time t using gamma, wherein tau0 is an external calibration anchor for relating an eight-tick time representation to SI time units and is not selected or tuned as a collapse-model fitting parameter.

4. The method of claim 1, wherein computing the time derivative comprises computing:
[C_hat, [C_hat, rho]] =C_hat\hat{ }2 rho−2 C_hat rho C_hat+rho C_hat\hat{ }2.

5. The method of claim 1, wherein computing the time derivative comprises implementing a Lindblad-form representation with Lindblad operator L=sqrt(2*epsilon)*C_hat.

6. The method of claim 1, further comprising precomputing and caching at least one operator quantity selected from C_hat\hat{ }2, an eigendecomposition of C_hat, an eigendecomposition of H, or a propagator U(dt8)=exp(−i H dt8).

7. The method of claim 1, wherein numerically integrating comprises a fourth-order Runge-Kutta integration scheme.

8. The method of claim 1, wherein numerically integrating comprises a split-step integration scheme that applies a unitary update and a collapse update in a controlled order.

9. The method of claim 1, further comprising monitoring at least one state metric selected from trace, Hermiticity, positivity, or purity, and applying trace normalization when abs(Tr(rho)−1) exceeds a trace tolerance delta_tr.

10. The method of claim 1, wherein C_hat is selected from a set consisting of a normalized position operator, a normalized mass operator, a number operator, a spin-projection operator, a charge-related operator, and a photon-number operator.

11. A system for objective-collapse quantum-state evolution, comprising:
(a) one or more processors; and
(b) memory storing instructions that, when executed by the one or more processors, cause the system to perform the method of claim 1.

12. The system of claim 11, further comprising an observables engine configured to compute at least one expectation value <O>according to <O>=Tr(rho O) from rho(t).

13. The system of claim 11, further comprising a hardware control interface configured to output a control signal generated based on at least one observable computed from rho(t).

14. An integrated circuit for objective-collapse state evolution, comprising:
(a) an input interface configured to receive at least a current state rho, a Hamiltonian H, and a collapse operator C_hat;
(b) a fixed-epsilon storage element storing a fixed collapse strength epsilon defined by epsilon=8* phi/pi where phi=(1+sqrt(5))/2;
(c) a datapath configured to compute a collapse contribution having a double-commutator structure based on C_hat and rho;
(d) an accumulator configured to combine the collapse contribution with a Hamiltonian commutator contribution to form a state derivative; and
(e) an integrator pipeline configured to generate an updated state from the state derivative, wherein epsilon is not modifiable by user code as a collapse-model fitting parameter.

15. The integrated circuit of claim 14, further comprising a trace normalizer configured to enforce Tr(rho)=1 within a tolerance.

16. The integrated circuit of claim 14, further comprising an observable extractor configured to compute at least one expectation value <O>according to <O>=Tr(rho O) from rho and output the expectation value.

17. A real-time quantum control method, comprising:
(a) receiving a measured observable value from a quantum device;
(b) computing, using a collapse simulator, an evolved quantum state estimate rho based on an objective-collapse master equation using a fixed collapse strength epsilon defined by epsilon=8*phi/pi where phi=(1+sqrt(5))/2;
(c) computing an error between a target value and at least one of the measured observable value or a predicted observable value derived from rho; and
(d) outputting a control signal to the quantum device based on the error, wherein the predicted observable value is computed as O_pred(t)=Tr(rho O) for a selected observable operator O.

18. The method of claim 17, wherein computing the error comprises e(t)=OO_target(t) (t) OO_measured(t)(t) and outputting the control signal comprises V_ctrl(t)=K_p*e(t).

19. A cloud-based objective-collapse simulation service, comprising:
(a) a network interface configured to receive a simulation request comprising a Hamiltonian H, a collapse operator C_hat, an initial state rho0, and a time range;
(b) a scheduler configured to assign the simulation request to compute resources;
(c) a simulation engine configured to evolve rho under an objective-collapse master equation using a fixed collapse strength epsilon defined by epsilon=8* phi/pi where phi=(1+sqrt(5))/2; and
(d) a response generator configured to transmit at least one of a time series of rho, a time series of observables, or a report.

20. A photonic quantum random number generator system, comprising:
(a) a photon source; (b) an optical splitting element configured to route photonic events to a plurality of detection channels; (c) a detector array configured to generate detection events; (d) an event processor configured to map detection events to discrete outcomes; and(e) a random-bit extractor configured to generate a bitstream from the discrete outcomes, wherein the system is configured to use a fixed collapse strength epsilon defined by epsilon=8*phi/pi where phi=(1+sqrt(5))/2, and epsilon is not selected or tuned as a user-adjustable collapse-model fitting parameter.
